(19) United States
(12) Patent Application Publication
(10) Pub. No.: US 2009/0293448 A1
(43) Pub. Date: Dec. 3, 2009

(54) Simplified thrust chamber recirculating cooling system

(76) Inventors: James Robert Grote, Mojave, CA (US); Thomas Clayton Pavia, Mojave, CA (US)

Correspondence Address: RAMIREZ & SMITH, PO BOX 341179, AUSTIN, TX, 78734, US

(21) Appl. No.: 12/120,833

(22) Filed: May 15, 2008

Related U.S. Application Data
(60) Provisional application No. 60/930,373, filed on May 15, 2007.

(51) Int. Cl. F02K 99/00

(52) U.S. Cl. 60/204; 60/267

(57) ABSTRACT

In some aspects a propulsion system includes a thrust chamber having a gap between an inner shell and an outer shell, the inner shell and the outer shell being attached together to form the thrust chamber. The rocket engine also includes a recirculating cooling system operably coupled to the gap in at least two locations and operable to recirculate a convective coolant through the gap.

### RELATED APPLICATION

This application claims the benefit of U.S. Provisional Application Ser. No. 60/930,373 filed May 15, 2007 under 35 U.S.C. 119(e).

### FIELD

This invention relates generally to propulsion systems, and more particularly to rocket engines.

### BACKGROUND

In conventional liquid propellant rocket engines, a main propellant injector sprays liquid propellants into a combustion chamber, where the propellants are burned. The burned propellants expand in an expansion nozzle, where the resulting gases increase in velocity and produce thrust. A thrust chamber encompasses both the combustion chamber and the expansion nozzle.

One of the propellants (usually the fuel) flows through coolant tubes or channels in the thrust chamber. The relatively cool propellant flowing in the coolant tubes or channels cools the thrust chamber and prevents the thrust chamber from failing or melting. These conventional fluid cooled engines are typically called regeneratively cooled engines because the engine uses one of the main propellant to cool the thrust chambers. Examples of regeneratively cooled engines are the Space Shuttle's SSME engine and the Apollo program's F-1 engine.

The thrust chambers of conventional regeneratively cooled engines include large numbers of individual coolant tubes, perhaps dozens to as high as one thousand coolant tubes, and above. The coolant tubes are brazed or welded together side-by-side like asparagus, or the coolant tubes cooling channels are fabricated from large, thick metal shells that require extensive machining, custom tooling, and custom processes to fabricate the fluid cooling channels (i.e. passages) in the thrust chamber. These types of coolant tubes and flow passages for regeneratively cooled thrust chambers are produced by a small number (perhaps several) of very specialized, high-overhead, expensive fabricators. The cooling system of the thrust chamber is very often a large part of the procurement expense of a rocket engine and requires long lead time to manufacture.

### BRIEF DESCRIPTION

The above-mentioned shortcomings, disadvantages and problems are addressed herein, which will be understood by reading and studying the following specification.

In one aspect, a recirculation cooling system for a rocket engine allows for the fabrication of a simplified, shell structure thrust chamber. The recirculation cooling system flows more convective coolant than is needed to cool the thrust chamber, the excess being pumped back to the coolant tank.

In some aspects, a rocket engine includes a thrust chamber having a gap between an inner shell and an outer shell, the inner shell and the outer shell being attached together to form the thrust chamber. The rocket engine also includes a recirculating cooling system operably coupled to the gap in at least two locations and operable to recirculate a convective coolant through the gap.

In further aspects, a method to cool a rocket engine includes circulating a convective coolant at least twice through a gap between an inner shell of a thrust chamber and an outer shell of the thrust chamber and expending the convective coolant to the extent that substantially no convective coolant remains in the rocket engine's cooling system when all of a propellant is expended.

In other aspects, a method to cool a rocket engine includes circulating a convective coolant at least twice through a gap between an inner shell of a thrust chamber and an outer shell of the thrust chamber and expending the convective coolant to the extent that substantially no convective coolant remains in the rocket engine's cooling system when all of the main propellant is expended. In yet other aspects, the expending includes dumping the convective coolant overboard through a coolant metering device or in the expansion nozzle or both.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a cross section side-view block diagram of a propulsion system having a recirculating coolant system;

FIG. 2 is a cross section side-view block diagram of the propulsion system's engine;

FIG. 3 is a cross section top-view block diagram of combustion chamber apparatus having film coolant orifices;

FIG. 4 is an isometric block diagram of a thrust chamber that shows a swirling flow of a layer of internal film coolant along the thrust chamber inside wall;

FIG. 5 is a cross section side-view block diagram of an alternative configuration for the propulsion system's engine having a shell and a spiraled coolant tube instead of a gap between two shells;

FIG. 6 is a cross section side-view block diagram of a sample bolting arrangement for securing the inner and outer shells together;

FIG. 7 is a flowchart of a method to cool a rocket engine through recirculation of a convective coolant;

FIG. 8 is a flowchart of a method to cool a rocket engine;

FIG. 9 is a block diagram of an engine control computer in which different methods can be practiced; and

FIG. 10 is a block diagram of a data acquisition circuit of an engine control computer in which different methods can be practiced.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The systems, methods and apparatus described herein involve low-cost rocket engine technology that can be used to produce liquid propellant rocket engines of a very wide range of thrust sizes or propellant combinations for private, commercial, or government aerospace programs. Such an engine technology provides liquid propellant rocket engines at greatly reduced cost and procurement times as compared to conventional rocket engines. In some instances, the systems, methods and apparatus described herein reduce the procurement lead time of rocket engines from 9-to-18 months to approximately 4-to-6 weeks and the procurement costs from millions of dollars per unit to tens of thousands of dollars per unit. The systems, methods and apparatus described herein provide much faster and less expensive development and reproduction of rocket engines of a very wide range of thrust sizes or propellant combinations (i.e. combination of fuel and oxidizer).

The detailed description is divided into five sections. In the first section, apparatus are described. In the second section, methods are described. In the third section, electrical hardware and the operating environments in conjunction with which implementations can be practiced are described. Finally, in the fourth section, a conclusion of the detailed description is provided.

### Apparatus Implementations

In this section, particular apparatus are described by reference to a series of diagrams.

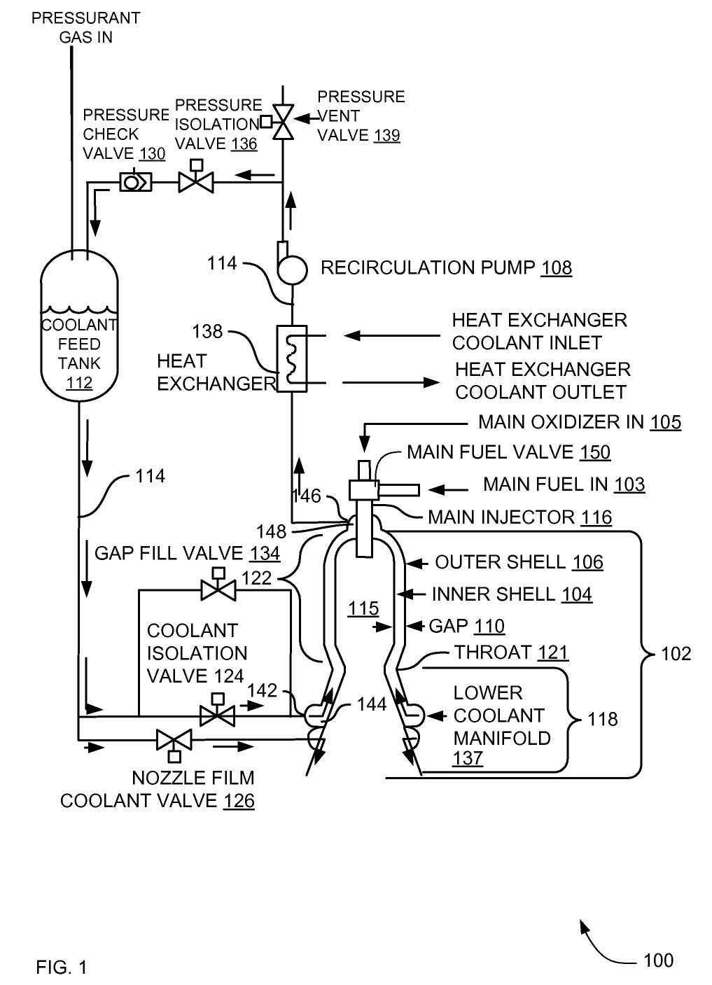

FIG. 1 is a cross section side-view block diagram of an overview of a propulsion system having a recirculating cooling system 100. Propulsion system 100 does not require extensive machining, custom tooling and fabrication custom processes. Fabrication of propulsion system 100 can be simplified to an extent where a balance is achieved between a low-cost rocket engine and a rocket engine that has enough performance (i.e. Isp performance) to fly useful missions.

FIG. 1 is a cross section side-view block diagram of a propulsion system 100 having a recirculating coolant system. Propulsion system 100 includes a rocket engine cooling system that does not require extensive machining, custom tooling and fabrication custom processes.

Propulsion system 100 includes thrust chamber 102 that has a double walled shell structure, the double-walled shell structure including and inner shell 104 and an outer shell 106. The inner shell 104 has a ‘hot wall’ adjacent to the combustion flames of the thrust chamber 102 and a ‘cold wall’ that is opposite to the hot-wall. The outer shell 106 has an ‘inner wall’ in between the two shells and an ‘outer wall’ that is the exterior surface of the thrust chamber 102. The double-walled trust chamber 102 is easy and simple to fabricate.

In propulsion system 100, the thrust chamber 102 is cooled with water (known as the ‘convective coolant’) that flows between the inner shell 104 and outer shell 106 by means of a recirculation pump 108. The convective coolant (water in this example) absorbs the heat that is conducted through the inner shell 104 from combustion gases of the propulsion system 100. The exact flow rate of the convective coolant required to cool a rocket engine depends on the materials of construction, the desired confidence level in the engine design, the heat flux flowing into the inner shell 104, and the desired maximum temperature of the structures of the rocket engine, but the flow rate of convective coolant will typically fall between 0.5% and 10% of the total fluid flow rate to the engine' thrust chamber 102. The total fluid includes main propellants (main fuel 103 and main oxidizer 105), film coolant, and convective coolant. The convective coolant is sometimes known as a conductive coolant.

A rocket thrust chamber 102 recirculating cooling system can be used to cool any type of rocket engine thrust chamber 102, whether the engine receives main propellants (main fuel 103 and oxidizer 105) delivered as a pressure-fed rocket engine (i.e. main propellants fed to the engine solely by pressurizing the main propellant tanks) or whether the rocket engine is pump-fed (i.e. where the main propellants are fed to the engine by a pump or pumps, usually but not always a turbopump/turbopumps). If implemented as shown in FIG. 1, the thrust chamber 102 cooling system can operate completely independently of the turbopump system making development of both systems easier and less costly.

To ensure that there is adequate cooling of the thrust chamber 102, more convective coolant is pumped through a gap 110 between the inner shell 104 and outer shell 106 than is required to cool the thrust chamber 102 below a maximum allowable temperature of the thrust chamber. The greater convective coolant flow rate maintains acceptable convective coolant velocity for adequate cooling and also gives higher cooling safety factor. In some implementations, about 1.1 to 20 times more convective coolant is pumped through the gap than is required to cool the thrust chamber below a maximum allowable temperature of the thrust chamber. Since excess convective coolant is flowing through the thrust chamber 102, that portion of convective coolant that is not expended during the cooling process is recirculated back to a convective coolant feed tank 112 for reuse with a recirculation pump 108. The recirculation pump 108 is located anywhere in a recirculating convective coolant loop 114. The recirculation pump 108 can be any type of pump that can pump the convective coolant. The recirculation pump 108 can be electrically, hydraulically, or pneumatically driven or driven by any other means so long as the recirculation pump 108 pumps the convective coolant.

The thrust chamber 102 is easy to fabricate because the larger convective coolant flow rate allows for a larger gap 110 between the inner shell 104 and the outer shell 106 of the thrust chamber 102. This larger gap in turn allows for a lower fluid pressure drop in the gap 110, less chance of plugging due to contaminants, less warpage effects, much looser gap tolerances, and less surface smoothing requirements.

A larger, wider gap 110 provides a greater flow rate of the convective coolant, with the excess convective coolant being recirculated via the recirculation pump 108 back to the coolant feed tank 112. The width of the gap 110 is directly proportional to the increase in the flow rate convective coolant. For example, consider a rocket engine with a conventional convective non-recirculating cooling system in which the sea level thrust is 25,000 lbs, a chamber pressure is 300 psia, propellants are Lox/Jet fuel with water convective coolant, the % water flow rate is 2.8% of total fluid flow (flow rate) to engine, a inner shell wall thickness of 0.026″, and a convective coolant velocity at throat region of 30 ft/sec, such an engine can have a gap around the engine's throat of about 0.0125″ wide. With a recirculation system of propulsion system 100, the flow rate of the convective coolant is increased by a factor of 10, to make the gap 110 wider, in which the gap becomes 0.125″. These figures should only be considered as examples and can vary widely. A wider gap 110 facilitates the production of low cost, easier to produce engines.

In some implementations, the gap is in a range of 0.04-0.25 inches, which provide looser tolerances in the dimensions and geometry between inner and outer shells eliminates wastage of coolant, and allows greater cooling when used with the coolant recirculation system.

The double-wall construction of the thrust chamber 102 with recirculation of convective coolant in the gap 110 provides looser acceptable values for gap tolerance. With the exemplary 0.125″ gap of the propulsion system 100, an acceptable tolerance can be +/−50% which would translate to +/−0.0625″ or a total tolerance of 0.125″. These amounts of tolerances are achievable with standard metal working of sheet metal, thus fabricating the thrust camber 102 from sheet metal is practical in propulsion system 100. Because cost increases and reductions in reliability increase largely with tighter tolerances, a reduction in tolerance requirements represents a potentially huge reduction in cost and production time. These numbers should be accepted as examples only and can vary.

In some implementations, the flow rate of the convective coolant flow rate is increased to maintain constant velocity above a burnout velocity as the gap dimension is increased in width, and the excess convective coolant is recirculated back to the coolant feed tank 112.

Propulsion system 100 has less convective coolant pressure drop in the gap. As the distance of the gap 110 becomes smaller, the pressure drop of the convective coolant flowing through the gap 110 dramatically increases due to the effects of surface friction between the fluid and the metallic wall. This occurs because surface friction translates into increased fluid boundary layer effects in a small gap. A gap of 0.0125″ has much more significant surface friction/boundary layer effects than a gap of 0.125″. For very tiny gaps (such as 0.0125″) the pressure drop can be very high, perhaps 5 to 50 times higher that of a larger gap. Pressure drops for tiny gap sizes are usually difficult to calculate and should be determined experimentally. The problem with these high pressure drops for small gap sizes is that they increase the horsepower of the recirculation pump and/or the pressure of the coolant feed tank 112 (and their weights) dramatically, making these items much less practical for a real working rocket vehicle. Thus, when the convective coolant flow rate is increased and the gap 110 is increased as well, these friction/boundary layer pressure losses are dramatically decreased to the benefit of the rocket system as a whole.

Propulsion system 100 has less surface smoothness requirements. As the gap 100 distance decreases the friction/boundary layer pressure losses increase. To help minimize these pressure losses, the inside surfaces of the gap (shells) can be polished or smoothed, the smaller the gap 110, the greater the need for extreme smoothing. This kind of smoothing can be difficult and expensive for the large surface area of a thrust chamber, especially if that area is contoured. This will only contribute to the complexity and expense of thrust chamber fabrication. Having a larger gap distance will greatly reduce or eliminate this smoothing/polishing altogether.

Propulsion system 100 has a higher convective cooling safety factor. In a thrust chamber without recirculation cooling, the maximum temperature for the convective coolant after one pass through the thrust chamber is variable but an acceptable value is 30 degrees less than the boiling point of the fluid. For water convective coolant this can be 182 degF for an ambient pressure water cooling system. Assuming the cooling water in the coolant feed tank 112 has a starting temperature of 36 degF, in a propulsion system 100 having convective coolant recirculation, there is a greater coolant flow rate; for example 10 times the rate without recirculation. In this case the temperature rise of the convective coolant with each pass through the thrust chamber 102 can be only 14.6 degF but would be 146 degF without coolant recirculation. This being the case and depending on the exact engine parameters, a propulsion system 100 having convective coolant recirculation will be able to handle 1.25 to 4.0 times the heat flux that a non-recirculating system can handle. This is very important if anomalies should develop in the thrust chamber 102 that increase the heat flux at any one location in the thrust chamber 102.

The output pressures of the recirculation pump 108 can be of a wide range of pressure, but in some implementations, the output pressure of the recirculation pump 108 is at least be enough to compensate for the pressure drop and ‘head’ difference (height difference) of the convective coolant as the convective coolant flows through the recirculating convective coolant loop 114, including acceleration effects. The output pressure of the recirculation pump 108 should also be less than the amount of pressure required to cause the inner shell 104 to collapse before the engine starts and the pressure in thrust chamber 102 increases to the operating pressure of the thrust chamber 102. Typical values (for example only, other values applicable) of the output pressure of the recirculation pump 108 output pressure can fall between approximately 5 to 100 psid (differential pressure across pump) but the ultimate value is determined by the pressure drop of the convective coolant loop 114, the height difference of the convective coolant loop 114, and the acceleration field that the convective coolant loop 114 is being subjected to.

Propulsion system 100 can use liquid oxygen (Lox) and jet fuel as the main propellant of the engine (i.e. the propellants that generate the bulk of the thrust of the rocket engine), as well as any other propellant. To reduce the amount of convective coolant required to cool the inner shell 104 to acceptable temperatures, propulsion system 100 includes one of two techniques or both: 1) film coolant and 2) application of a ceramic or metal layer such as a metal oxide or anodizing of the hot-gas surface of the inner shell 104. Anodizing is appropriate only for materials of the inner shell 104 that can be anodized such as aluminum. Film coolant is a liquid or gas that flows along the hot-wall surface of the inner shell 104. In propulsion system 100, the film coolant is jet fuel that is injected along the inner shell 104 hot-gas wall. The jet fuel film coolant reduces the heat to be absorbed by the convective coolant by, upon evaporation and/or decomposition of the film coolant, depositing carbon (soot) on the hot-wall surface of the inner shell 104. The carbon or soot is an excellent insulator that greatly reduces the transmission of heat to the convective coolant. The process of depositing soot on the hotwall of the inner shell 104 is called ‘coking’, jet fuel being a ‘coking’ fluid. The amount of film coolant utilized can be within a wide range and depends on the maximum desired hot wall temperature of the engine and the materials of construction, but the amount usually falls between 0 and 10% of the total fluid flow to an interior 115 of the thrust chamber 102. The total fluid includes both the main propellants (main fuel 103 and oxidizer 105) and film coolant. The internal film coolant can be either a coking or noncoking fluid, but is shown as a coking fluid as the baseline for the systems, methods and apparatus disclosed.

In addition, anodizing the hot-wall surface of aluminum inner shell 104 produces a layer of aluminum oxide on the hot-wall surface. Aluminum oxide is also a very good insulator and, like carbon, can withstand very high temperatures (approx. 3500 degF and greater).

In propulsion system 100, a main propellant injector 116 is a Pintle injector such as was developed by TRW in the 1960's. However the thrust chamber 102 cooling system of propulsion system 100 can be used with any rocket main propellant injector 116 as discussed below.

In many cases, when used in a flying rocket vehicle, the convective coolant must be gradually expended (i.e. dumped overboard) somehow. In a particular implementation, the convective coolant is expended overboard the flight vehicle during rocket engine operation such that the coolant feed tank 112 is empty or near empty at the moment of engine shutdown. If not, then at the end of the flight of vehicle, the coolant feed tank 112 will be just as full at the end of the operation engine as the coolant feed tank 112 are at the start of engine operation. This can lead to a heavier vehicle at engine shutdown and thus result in the vehicle being able to carry less useful payload. In addition, if convective coolant is not dumped overboard in a gradual and measured way, the convective coolant in the coolant feed tank 112 can rise in temperature until the temperature in the convective coolant in the coolant feed tank 112 is at or near a boiling point (assuming the cooling system is used without a heat exchanger 138). There is an option to this ‘dumping overboard’ mode of the convective coolant that is discussed below, but gradually expending the convective coolant overboard is the propulsion system 100. In propulsion system 100, piping, tubing, and/or hose or other means connects the main components as helpful.

Three possible methods to expend convective coolant during engine operation are:

a.) cooling an expansion nozzle 118 using convective coolant injected along the inner wall of the expansion nozzle as a film coolant. In propulsion system 100, the convective coolant is routed to the expansion nozzle 118 where convective coolant is injected along the hot wall of the nozzle to be used as a film coolant that cools part or all of the expansion nozzle 118. The convective coolant, used in the expansion nozzle 118 as film coolant, can be injected anywhere in the nozzle using any means of injection, but injecting convective coolant at a nozzle expansion area ratio somewhere between 2 to 4 are a typical example. In cooling the expansion nozzle 118 by using convective coolant, a low static pressure exists in the flowfield of the expansion nozzle 118, thus the coolant feed tank 112 and/or the recirculation pump 108 can be run at lower pressures (i.e. slightly higher than the static pressure of the expansion nozzle 118) while still being able to cool the nozzle. Lower tank and pump output pressures provide lower vehicle weights and thus the rocket vehicle can carry more useful payload. The expansion nozzle 118 cooling method can be used alone or in combination with a coolant metering device (not shown in FIG. 1). The area ratio of an expansion nozzle 118 is the ratio of a cross sectional area of the nozzle at a specified location (in the nozzle) to the cross sectional area of a throat 121 of the thrust chamber 102 (i.e. the narrowest part of the thrust chamber 102).

b.) Dumping the convective coolant overboard through a coolant metering device. In some implementations, the convective coolant is gradually dumped overboard through the coolant metering device. The coolant metering device can be an orifice or valve or some other fluid flow-metering device or combination of devices. The coolant metering device can be passive or actively controlled. The coolant metering device can also be used by itself or in combination with using the convective coolant as film coolant in the expansion nozzle 118.

c.) Using the convective coolant as a film coolant in the combustion chamber: After the convective coolant travels through the gap 110 between the inner shell 104 and the outer shell 106 a portion of convective coolant can be injected along the hot-wall of the combustion chamber 122 as the film coolant while the remainder of the convective coolant is pumped back to the convective coolant feed tank. In propulsion system 100, the combustion chamber 122 film coolant is jet fuel.

In some implementations, the propulsion system 100 includes as many as six valves, such as a pressure isolation valve 136, a coolant isolation valve 124, a nozzle film coolant valve 126, a pressure vent valve 139, a pressure check valve 130, and the gap fill valve 134. These valves can be implemented by single or multiple valves or can be used alone or in combination with any other of these valves. These valves are significantly helpful under the following circumstances:

In applications where the pressure in the gap 110 between the inner shell 104 and outer shell 106 is always less than the critical pressure required to collapse the inner shell 104 prior to engine startup (i.e. before the main propellants 103 and 105 are burning and there is pressure in the combustion chamber 122), then any of the valves mentioned above are optional with the exception of the nozzle film coolant valve 126 which is optional depending of film cooling timing/control requirements. One or all of them can be used depending on how much control is required over the cooling process. Another optional valve is a film coolant valve 215 on the combustion chamber. The internal film coolant 210 can be fed directly from the gap 110 or from the external coolant tube(s) 504 without a valve for the film coolant, or the internal film coolant 210 can be fed from a valve dedicated distributing the film coolant and manifold as shown in FIGS. 1, 2, and 5. Or the internal film coolant 210 can be fed without its own valve from a tube(s) branching off downstream of a main fuel valve 150. Likewise the expansion nozzle film coolant 222 can fed from its own valve such as the nozzle film coolant valve 126 in FIG. 1 or it can be fed without its own valve but with a tube(s) branching off downstream of the coolant isolation valve 124 or fed directly from a lower coolant manifold 137.

However, there are two applications where the gap pressure will be high enough to collapse the inner shell 104 prior to engine startup (i.e. prior to buildup of pressure in the combustion chamber 122).

a.) High coolant Passage Pressure Drop: When the sizing of the convective coolant flow passage is such that the pressure drop through the convective coolant flow passage is high enough to require a recirculation pump 108 output pressure or coolant feed tank 112 operating pressure that is high enough to collapse the inner shell 104 prior to engine startup. The convective coolant flow passage is all the piping, plumbing, and the Gap 110 of the coolant recirculation loop.

b.) Higher Gap Pressure Means Higher coolant Boiling Temperature: The higher the convective coolant pressure when the coolant is in the gap 110, the higher the boiling temperature will be, and thus the higher the amount of heat the convective coolant can absorb before boiling, and thus the lower the required convective coolant flow rate to cool the thrust chamber 102. A lower required flow rate of convective coolant means a smaller recirculation pump 108 and coolant feed tank 112 and thus a rocket vehicle with less tankage and inert weights and a higher useful payload weight.

When the convective coolant fluid operating pressure in the gap 110 is higher than the external collapse pressure of the inner shell 104, then pressure in the gap 110 cannot increase to a full operating value of the gap 100 until the engine has started and the combustion chamber 122 pressure is at the full operating value (300 psia as an example). This is accomplished as follows:

Prior to engine startup, the gap 110 in between the inner shell 104 and outer shell 106 is filled with convective coolant. The filling is performed by opening then closing the coolant isolation valve 124 before the coolant feed tank 112 is fully pressurized such that the pressure of the convective coolant system is not enough to collapse the inner shell 104. The coolant feed tank 112 is then fully pressurized after the coolant isolation valve 124 and the pressure isolation valve 136 are closed. Note that pressure isolation valve 136 can be used in conjunction with a pressure check valve 130, or the pressure check valve 130 can be used by itself in place of the pressure isolation valve 136. If the coolant feed tank 112 is fully pressurized to an operating pressure prior to opening the coolant isolation valve 124 then filling the gap 110 prior to engine start is accomplished with the gap fill valve 134. The gap fill valve 134 is a manual or actuated valve that can be briefly opened to fill the gap 110 with convective coolant prior to the coolant isolation valve 124 opening. The gap fill valve 134 is used in conjunction with opening the pressure vent valve 139 in order to fill the gap 110. The gap fill valve 134 and the pressure vent valve 139 can be replaced with ports that are simply plugged after gap 110 filling. After the gap 110 is filled the gap fill valve 134 and the pressure vent valve 139 are closed. As an option the gap fill valve 134 can be a small valve or has an orifice or metering device built into so that during the filling process the gap 110 pressure never exceeds the collapse pressure of the inner shell 104. The gap 110 filling can also be accomplished by opening and closing the gap fill valve 134 very quickly in successive pulses to keep the gap 110 pressure below the critical collapse pressure. Or the gap 110 can be filled from the coolant feed tank 112 prior to pressurizing that tank beyond the collapse pressure of the inner shell 104, or filled from a separate low pressure source that will not collapse the inner shell 104.

Once the gap 110 is filled with convective coolant and the gap fill valve 134 and the pressure vent valve 139 are closed, the engine is started as follows:

At nearly the same time or just after (perhaps a few milliseconds to dozens of milliseconds as an example) the main propellants (main fuel 103 and oxidizer 105) have ignited in the combustion chamber 122 and pressure is building up in the combustion chamber 122 the coolant isolation valve 124 and the pressure isolation valve 136 are opened to allow convective coolant to begin flowing through the gap 110 the moment that the recirculation pump 108 starts. The nonflowing convective coolant that filled the gap 110 prior to opening the coolant isolation valve 124 will cool the thrust chamber 102 for the short duration (perhaps 0.010 second to 0.1 second as an example range) that the main propellants (main fuel 103 and oxidizer 105) are burning in the combustion chamber 122 and prior to opening the coolant isolation valve 124. Once the coolant isolation valve 124 and pressure isolation valve 136 opens, the combustion chamber 122 pressure is high enough to prevent the gap 110 pressure from collapsing the inner shell 104 and when the recirculation pump 108 starts the convective coolant flows through the gap 110 to cool the thrust chamber 102. The pressure isolation valve 136 can open slightly sooner than the coolant isolation valve 124 or nearly the same time. Prior to the opening of the coolant isolation valve 124 and the pressure isolation valve 136 the convective coolant is in a trapped space in the gap 110 and thermal expansion effects can cause the convective coolant to collapse the inner shell 104. To prevent collapse of the inner shell caused by the expansion effects of the convective coolant, the pressure vent valve 139 is opened and closed to the extent that the thermal expansion pressure is relieved to prevent collapse of the inner shell 104. The pressure vent valve 139 can be used to relieve any kind of pressure buildup that can collapse the inner shell 104, or another type of relief device can be used.

The entire thrust chamber 102 can be cooled with convective coolant flowing through the gap 110, or a portion of the expansion nozzle 118 can be cooled by using convective coolant as film coolant. The convective coolant used as film coolant in the expansion nozzle 118 can be flowed through a plumbing branch or manifold downstream of the coolant isolation valve 124 without a separate nozzle film coolant valve, or the convective coolant can be controlled with a valve dedicated to distribution of the convective coolant, called the nozzle film coolant valve 126, for improved control and timing of initiation of flow or the convective coolant can simply feed off of the lower coolant manifold 137. If a nozzle film coolant valve 126 is included, an inlet of the nozzle film coolant valve 126 can branch-off upstream of the coolant isolation valve 124 as shown in FIG. 1 or just upstream of a heat exchanger 138 or anywhere else in the recirculating convection coolant loop 114.

Some implementations of the propulsion system 100 also include a heat exchanger 138 for cooling the convective coolant of the heat the convective coolant has absorbed in the thrust chamber 102. Propulsion system 100 having convective coolant recirculation provides the option of circulating this coolant fluid, using the recirculating pump, through the heat exchanger 138 that uses as heat exchanger working coolants one or more of the following fluids which could be liquids or gases: fuel, oxidizer or pressurant gas. This can have the beneficial effect of a) reducing the total convective coolant and b) adding energy to the heat exchanger working coolants, thus increasing engine or pressurant efficiency. The benefits that can accrue from the use of a heat exchanger can be to permit reduction of coolant weight and/or increase engine and/or pressurant efficiency, which can allow either reducing vehicle size for a given payload, or increasing payload for a fixed propellant size. A heat exchanger of sufficient size can resemble a closed (except for any coolant bled off into the nozzle) low-pressure, pump circulated radiator not unlike a liquid-cooled automotive engine coolant system.

A recirculating cooling system 140 includes a number components in the propulsion system such as the recirculating convective coolant loop 114 that couples the coolant metering device, gap 110, the heat exchanger 138, recirculation pump 108, the pressure isolation valve 136, the pressure check valve 130, the coolant feed tank 112, the nozzle film coolant valve 126, the coolant isolation valve 124 and the gap fill valve 134.

When the recirculating cooling system 140 is part of a rocket engine in flight (i.e. on board a flying rocket vehicle). A coolant metering device is one of the optional components. The purpose of the coolant metering device is to dump convective coolant during the rocket vehicles flight in order to end up with zero or near zero convective coolant left in the coolant feed tank 112 when the mission is done and the engine has shut down. If excess convective coolant remains on the vehicle at engine shut down, then the vehicles burnout weight is excessive and the weight of the remaining convective coolant can result in less payload carried by the vehicle. The convective coolant can be dumped into the atmosphere and/or injected along the engines' expansion nozzle 118 hot wall, at/or downstream of the throat 121 of the thrust chamber (i.e. the narrowest part of the thrust chamber 102) in order to act as film coolant to cool the expansion nozzle 118. To accomplish this, the coolant metering device can be either an actively controlled or preset device. The coolant metering device can be used by itself to dump excess convective coolant or can be used in conjunction with using convective coolant as film coolant in the expansion nozzle 118. The heat exchanger 138 is optional and can be placed anywhere in the recirculating cooling system 140. The convective coolant can also be injected into the expansion nozzle 118 as film or dump coolant without a separate coolant metering device as is shown in FIG. 1.

The following section provides descriptions of various options to propulsion system 100 that have not yet been described in the previous sections.

Option 1, geometry of the combustion chamber 122: The recirculating cooling system 140 can be used with any geometry of combustion chamber 122 including the conventional ‘cylindrical’ combustion chambers (as in most rocket engines today) and ‘spherical’ combustion chambers (such as in the German WW2 V2 rocket engine). Likewise the outer shell 106 of the thrust chamber 102 can be of any geometry so as long as the gap between the inner shell 104 and the outer shell 106 is sufficient to allow the sufficient flow of convective coolant to cool the thrust chamber 102, cooling especially the inner shell 104. The thrust chamber 102 can be of any geometry, so long as the thrust chamber 102 is able to function as a rocket thrust chamber 102.

Option 2, engine main propellants: Because the recirculating cooling system 140 operates independently of the main propellant injector 116, the cooling system can be used with rocket engines using any type of main propellants (main fuel 103 and oxidizer 105) including jet fuel, RP-1, kerosene, liquid hydrogen, liquid methane, propane, liquid oxygen, hydrogen peroxide, alcohol, nitric acid, and others.

Option 3, main propellant injector: Because the cooling system operates independently of the main propellant injector 116, the cooling system can be used with rocket engines utilizing any type of main propellant injector 116 including the Pintle injector originally developed by TRW in the 1960's or so-called “flat-face” injectors such as utilized in the Space Shuttle Main Engine (SSME) and the Apollo J-2, H-1, and F-1 engines.

Option 4, film coolant: To reduce the flow rate and amount of convective coolant required, the recirculating cooling system 140 can be used with film coolant injected along the hot wall of the thrust chamber 102. The film coolant is not a necessity but the film coolant can be used with the recirculating cooling system 140. The film coolant can be injected in the thrust chamber 102 in any manner or number of places. In addition, any fluid can be used as film coolant as long as cooling properties of the fluid are known and how the fluid interacts with the recirculating cooling system 140 is also known.

Option 5, convective coolant: The type of fluid used as convective coolant in the recirculating cooling system 140 can be any liquid, supercritical fluid, or gas as long as the fluid can absorb the heat flowing through the inner shell 104 of the thrust chamber 102 while allowing the inner shell 104 to remain cool enough so that the inner shell 104 does not melt or fail structurally during engine operation. Water is an ideal conducive coolant, but the convective coolant can also be one of the main propellants (main fuel 103 and oxidizer 105) of the engine such as liquid hydrogen, liquid methane, liquid oxygen, hydrogen peroxide, jet fuel, kerosene, rocket fuel, or others. Liquid nitrogen can also be used. Any fluid, including a gas, can be used as the convective coolant as long as the fluid can absorb the heat that flows into the thrust chamber 102 form the engine's combustion process. In those cases where the convective coolant is one of the rocket engine's main propellants (main fuel 103 and oxidizer 105), then an option is the appropriate main propellant tank acting as both the convective coolant feed tank 112 and as a main propellant tank.

Option 6, convective coolant additives: The convective coolant can be a pure fluid, a mixture of fluids, or a fluid with the addition of additives to obtain specific coolant characteristics. For example, if water is used as the convective coolant the water can include additives that have an effect of either lowering the freezing point of the water, raise the boiling point of the water, reduce the corrosion potential of the water or to achieve any other effect so long as the water still can absorb the heat from the thrust chamber 102. Another alternative is prechilled convective coolant that is thermally adjusted prior to use in the recirculating cooling system 140.

Option 7, recirculation pumps: The convective coolant recirculation pump 108 can be any type of pump that can move a fluid and can be driven by any type of energy source. The pump of propulsion system 100 is a centrifugal pump driven by an electric motor. Likewise any number of pumps can be used anywhere in the convective coolant flow path as long as the pump (pumps) keep the convective coolant flowing at the desired times.

Option 8, thrust chamber materials/processes of construction: The thrust chamber 102 can be made with any materials or processes can create shell structures of the appropriate size, geometry, and structural strength and that allow the heat absorbed by the thrust chamber 102 to be absorbed by the convective coolant to the extent where the thrust chamber will not get so hot as to melt or structurally fail due to material heating. Example materials for the thrust chamber 102 include, but are not limited to, copper, aluminum, steel, stainless steel, nickel, Inconel, brass, bronze and alloys and/or composites of all of the above materials, any combination of the above materials, or any material that has the strength and heat transfer requirements of the specific rocket engine being designed. The primary material of construction for the propulsion system 100 is an alloy of an Inconel alloy. Inconel is a registered trademark of Special Metals Corporation of New Hartford, N.Y. that refers to a family of austenitic nickel-based superalloys. Inconel® alloys are oxidation and corrosion resistant materials well suited for service in extreme environments. When heated, Inconel® forms a thick, stable, passivating oxide layer protecting the surface from further attack. Inconel® retains strength over a wide temperature range, which is helpful in implementations where aluminum and steel can soften. The heat resistance of Inconel® is developed by solid solution strengthening or precipitation strengthening, depending on the alloy.

Option 9, surface enhancements: The surface characteristics of the cold-wall (outside wall or exterior) of the inner shell 104 can be modified to increase the heat transfer coefficient (btu/in̂2-sec-degF) of the recirculating coolant system 140. A higher heat transfer coefficient means that the inner shell 104 can absorb/conduct heat at a higher rate while having lower overall wall temperatures. The enhancements to the cold wall of the inner shell 104 include but are not limited to smoothing, roughing, sanding, sand blasting, grit blasting, shot peening, sputtering, and/or machining or forming grooves or patterns into the cold-wall as well as other methods. Another option is to plate the cold-wall with a highly convective metal such as gold, silver, nickel, or copper. Still another option is to flame spray or plasma spray or use some other process (including painting) to install a metallic surface onto the cold-wall of the inner shell 104. These modifications and other types of surface enhancements can also be done to the surfaces adjacent to the cold-wall of the inner shell 104 in any combination with any other modification in order to achieve a required heat transfer coefficient.

The hot-wall of the inner shell 104 can be modified to reduce heat flux conducting through the inner shell 104 to the convective coolant. One method is to use the inner shell 104 parent material as-is without any coatings. Another is to anodize the hot wall for those materials that can be anodized such as aluminum. Anodizing creates and heat resistant oxide layer on the material that reduces the amount of heat conducted through the inner shell 104. Another modification to reduce heat conduction is to deposit a ceramic, metal, or composite layer on the inner shell 104 hot-wall. Still another modification to the inner shell 104 hot-wall is to increase resistance of the inner shell 104 hot-wall to oxidation by combustion gases. Resistance of the inner shell 104 hot-wall to oxidation can be achieved by depositing a ceramic, metal oxide, metal nitride or carbide, or metal layer on the hot-wall using flame spraying, plasma spraying, vapor deposition, plating, or any other deposition technique. Example metals that can be deposited on the hot wall for this purpose are Inconel, nickel, copper, brass, stainless steel, gold, silver, ceramics, metal oxides, metal nitrides, metal carbides, and others.

Finally, coating the thrust chamber 102 parent materials (includes the inner shell 104 and outer shell 106) can be helpful when required to protect the trust chamber 102 from the corrosive effects of the convective coolant when applicable. In this case, an alternative is to coat the portions of the thrust chamber 102 that are in contact with the convective coolant with a coating to protect the thrust chamber 102. As an example, with an aluminum alloy thrust chamber 102, the ‘inner wall’ of the outer shell 106 and the ‘cold wall’ of the inner shell 104 can be coated with gold plating to protect the inner shell 104 and the outer shell 106 from the effects of water as the convective coolant. Any process or coating material can be used so long as the protective effects are realized without inhibiting the convective coolant from absorbing the heat that is conducting through the inner shell 104.

Option 10, cooling the convective coolant: After the convective coolant has cooled the thrust chamber 102, the convective coolant will have been warmed from the heat that the convective coolant absorbed from the thrust chamber 102. As an option, the convective coolant can be run through a heat exchanger 138 to cool the convective coolant as the convective coolant is being pumped back to the coolant feed tank 112. The heat exchanger 138 can be located anywhere in the convective coolant flow loop 114. The heat exchanger 138 can take the form of a coiled tube(s), a coiled and finned tube(s), straight tubes, straight finned tubes, or any other configuration that is suitable for cooling the convective coolant. The fluids used to cool the convective coolant are one or both of the rocket engine main propellants (main fuel 103 and oxidizer 105). To cool the convective coolant the heat exchanger 138 can be located at one of several possible locations: inside the main oxidizer tank, inside the main fuel tank, or inside both main propellant tanks, inside the main pressurant gas tank, inside the main oxidizer feedline (that feeds the engine), inside the main fuel line (that feeds the engine), inside the main pressurant gas line (that pressurizes the main propellant tanks), or wrapped around the outside of the main fuel, oxidizer, or pressurant gas lines or a portion of either or both main propellants can be routed to the heat exchanger 138 by a separate line. Any combination of lines can be used. If the heat exchanger 138 is located inside one of the propellant tanks, a small pump that is operable to pump main propellant over the heat exchanger 138 to absorb heat from the convective coolant. A portion of either or both of the main propellants (main fuel 103 and oxidizer 105) can be diverted, with a pump or pressure, into the heat exchanger 138 to cool the convective coolant and then is dumped overboard the rocket vehicle or is rediverted to feed or cool the engines. Again, the heat exchanger 138 is an option and is also an option to run the cooling system of this system without one. The heat exchanger 138 can be of any location and configuration using any fluid within a rocket vehicle or system so long as the heat exchanger 138 absorbs the heat the convective coolant has absorbed in the thrust chamber 102. The possible heat exchanger 138 configurations include spraying one or both of the main propellants (main fuel 103 and oxidizer 105) on the heat exchanger 138 to absorb heat.

Closed loop option: If enough of the main propellants (main fuel 103 and oxidizer 105) can be used to cool the convective coolant so that all of the heat absorbed by the convective coolant in the thrust chamber 102 is then absorbed by the one or both of the main propellants (main fuel 103 and oxidizer 105) and/or pressurant gas, then the convective coolant can release enough additional heat (absorbed in the thrust chamber 102). Thus, only a very small amount of the convective coolant running in the totally closed convective coolant loop 114 is required to cool the thrust chamber 102. In this case either no coolant feed tank 112 or only a very small coolant feed tank 112 are required. In this way, the average overall temperature of the convective coolant can not increase or increase significantly (having given absorbed heat of the convective coolant to the main propellant/propellants, or pressurant gas) thus the convective coolant's coolant feed tank 112 can be very small or absent as compared to a system where convective coolant is being dumped overboard (from a rocket engine or rocket vehicle) or is being used to cool the expansion nozzle 118 as film coolant.

Option 11, gap spacing: There are many options of maintaining the gap 110 between the inner shell 104 and outer shell 106. The gap 110 can be void with no structures or solid items in the gap 110; or for example, spacers can be located in the gap 110 of any geometry, size, or material; the gap 110 can have ribs that are formed or machined on the ‘cold wall’ of the inner shell 104 and/or the ‘inner wall’ of the outer shell 106; the gap 110 can include ribs that are loose but installed in the gap 110; the gap 110 can include ribs that are bonded or secured to the inner shell 104 and outer shell 106 using any methods. Spacing of the gap 110 can be maintained by rivet, bolt, or screw heads, rivets, bolts or screws that protrude through the outer shell 106, but have their heads within the gap 110, the heads acting as spacers and the inner shell 104 and outer shell 106 being unattached to each other except at their ends. The rivets, bolts or screws are sealed against the outer shell 106 to prevent convective coolant leakage with solder, braze, or polymer sealant but any sealing method will do so long as the sealing method does not impair the heat absorbing ability of the recirculating cooling system 140, nor the structural integrity of the rocket engine.

The inner shell 104 and outer shell 106 can be only attached to each other directly or indirectly at their ends, or they can be secured to each other intermittently across their surfaces with rivets, bots, welded studs, welding, brazing, or by other means. One reason for securing the inner shell 104 and outer shell 106 to each other is that this can prevent the inner shell 104 from collapsing from higher convective coolant pressures. In this case the gap 110 can be prefilled with convective coolant at full pressure without the use of valve timing to prevent the collapse of the inner shell 104.

The inner shell 104 and outer shell 106 can be replaced by a thrust chamber 102 made of bundled tubes much in the same way as conventional regeneratively cooled rocket engines, or the thrust chamber 102 can be made like other regeneratively cooled rocket engines utilizing rectangular or semi-rectangular coolant channels that are sealed with electroplating or plasma spraying or other methods.

The exact method of building the thrust chamber 102 depends on how expensive the rocket engine will be. As long as the convective coolant can absorb the heat conducted to convective coolant by the rocket engine and as long as the rocket engine can maintain adequate structural integrity to perform the mission of the rocket engine, a simplified thrust chamber 102 structure can be used as shown in FIGS. 1-2 and 5 or a more complicated thrust chamber 102 design similar to conventional regeneratively cooled rocket engines.

So, for a simple shell-structure thrust chamber 102 the inner shell 104 and outer shell 106 can be free floating from each other (i.e. secured to each other only at their ends, either directly or indirectly), or can have any type of rib or spacer in the Gap made of any material that is compatible with the convective coolant and secured using any methods, or the inner shell 104 and outer shell 106 can be secured to each other intermittently across their surfaces using any method including bolts, rivets, studs, welding, brazing, soldering, and bonding of any kind, including adhesive bonding.

Option 12, valve usage: The basic recirculating cooling system 140 of the systems, methods and apparatus described herein requires the use of a thrust chamber 102, a recirculating pump, convective coolant, and a heat exchanger 138 or a coolant feed tank 112 or both a coolant feed tank 112 and a heat exchanger 138 and, of course, pipe or tubing to connect these components together. Any valves in the system are optional and can be added to improve coolant handling, loading, and draining, system operation and timing, safety, minimizing convective coolant quantity, and/or to prevent collapse of the inner shell 104 in those applications where the convective coolant system is at a higher pressure than the minimum collapse pressure of the inner shell 104. The optional valves include manual valves, actuated valves, relief valves, check valves, and others, and can be located anywhere in the convective coolant system to achieve the desired results.

Option 13, pump or pressure fed: This type of rocket thrust chamber 102 recirculating cooling system 140 can be used to cool any type of rocket engine thrust chamber 102 whether the engine has main propellants (main fuel 103 and oxidizer 105) fed as a pressure-fed rocket engine (i.e. main propellants fed to the engine solely by pressurizing the main propellant tanks) or as a pump-fed rocket engine (i.e. where the main propellants are fed to the engine by a pump or pumps, usually but not always turbopump(s). If used as shown in FIG. 1 the thrust chamber 102 cooling system can operate completely independently of the turbopump system making development of both systems easier and less costly.

Option 14, convective coolant flow direction: The convective coolant can flow in either the ‘up’ or ‘down’ directions or in any other direction, including circumferentially, as long as the convective coolant can cool the thrust chamber 102. That is, the convective coolant can start at the expansion nozzle 118 and flow upwards towards the main propellant injector 116 as previously described, or the convective coolant can start flowing near the injector-end of the engine and flow downward towards the expansion nozzle 118 before being routed back to the coolant feed tank 112 or to both the coolant feed tank 112 and as film coolant for the expansion nozzle 118. In the example of propulsion system 100, the convective coolant passes in and/or out of the gap 110 from an entry point 142 into a first location 144 of the gap 110 and an exit point 146 at a second location 148 in the gap 110.

Option 15, phase of convective coolant: The convective coolant can perform a cooling function in the liquid phase (all liquid), as a nucleate boiling liquid (i.e. with collapsing bubbles), as a boiling liquid (two phase fluid), as a supercritical fluid, or in the gaseous state (as a gas or vapor), or in any combination of these three fluid states. Another option is to pre-chill the convective coolant prior to use of the convective coolant in cooling the thrust chamber 102. The convective coolant can be pre-chilled by continuing to cool the convective coolant before or after loading the convective coolant into the coolant feed tank 112, or by cooling the convective coolant with a heat exchanger 138 with one or all of the rocket engine primary propellants as described above for cooling convective coolant after the convective coolant has absorbed heat from the thrust chamber 102. Pre-cooling the convective coolant will allow the convective coolant to absorb more heat from the thrust chamber 102 prior to boiling, thus less convective coolant flow rate is helpful and likewise less total quantity of convective coolant is required.

Option 16, cooling injectors: In addition to cooling the thrust chamber 102 and/or the expansion nozzle 118 the convective coolant can be used to cool any portion of the main propellant injector 116. In some implementations, the gap 110 is between less than the entirety of the inner shell 104 and the outer shell 106 and the convective coolant recirculates through a portion of the thrust chamber 102.

17.) Option 17, coolant feed tank pressure control: In implementations where the coolant feed tank 112 is used at a pressure that is higher than the critical collapse pressure of the inner shell 104 then, as described above, the opening speed of the coolant isolation valve 124 and the pressure isolation valve 136 is used to control the pressure in the gap 110 to prevent the gap 110 from coming up to full system pressure until after the engine has started and the combustion chamber 122 has come up to enough pressure to prevent the inner shell 104 from collapsing. This is accomplished by controlling the coolant isolation valve 124 and the pressure isolation valve 136 such that the combustion chamber pressure rises slightly faster than the gap 110 pressure and is thus always higher than the gap 110 pressure. An option to this method (using valve control) is to use the pressurization of the coolant feed tank 112 to prevent collapse of the inner shell 104. With this method the coolant feed tank 112 pressure is kept below the collapse pressure of the inner shell 104, but is increased to full operating pressure only after the engine has started and the combustion chamber 122 is at a high enough pressure to prevent inner shell 104 collapse. Valves of any type can still be used in the recirculating cooling system 140 to control the coolant feed tank 112 pressure to prevent collapse of the inner shell 104. At the end of the engine operation the pressure of the coolant feed tank 112 (and thus of the recirculating cooling system 140) is decreased to prevent inner shell 104 collapse as the combustion chamber 122 pressure comes down, or the inner shell 104 is simply allowed to collapse (i.e. the pressure of the coolant feed tank 112 is not decreased) because the engine has performed its mission.

Yet another option is to simply have the coolant feed tank 112 pressure constantly below the collapse pressure of the inner shell 104 so collapse of the inner shell 104 is not possible at any time during cooling system operation.

Option 18, processes and materials: The thrust chamber 102 is made of a thin sheet metal or sheet metal composite. The thin sheet metal or sheet metal composite can be made to any wall thickness depending on the size and combustion chamber pressure of the engine, but 0.020″ to 0.1″ are typical. Any process or material or combination of these can be used to make the thrust chamber 102 as long as the thrust chamber 102 is of the appropriate thickness to take the structural and pressure loading of the thrust chamber 102 and will sufficiently conduct heat through the inner shell 104 to the convective coolant. Possible materials for the thrust chamber 102 include Inconel, stainless steel, steel, copper, aluminum and alloys or composites of all of these materials or other materials. The outer shell 106 can be reinforced by wrapping the outer shell 106 in a composite material such as a filament wound overwrap such as graphite/epoxy, Kevlar/epoxy, or glass/epoxy or their equivalents or any other type of fiber/matrix composite either as a filament or tape winding or as a composite material cloth that is bonded or secured to or encircles the exterior surface of the outer shell 106. In addition, metallic stiffening ribs or structures can be welded, brazed, bonded, or soldered to the outer shell 106 to stiffen and strengthen the thrust chamber 102. Other options for this include formed composite ribs and structures of any geometry that are bonded or secured to the exterior surface of the outer shell 106 for the same purpose (of strengthening or stiffening the thrust chamber 102). Any structure can be added to the outside surface of the thrust chamber 102 to strengthen or stiffen the outside surface of the thrust chamber 102 because these structures do no effect the functioning of the cooling system presented here.

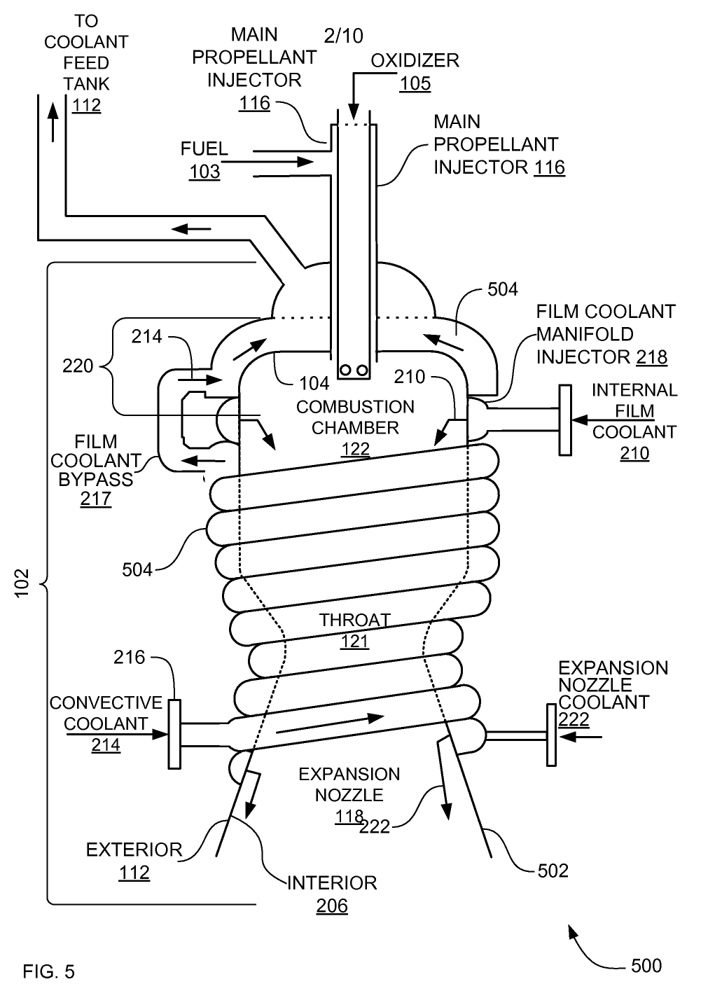

Option 19, a propulsion system having a single shell as described in greater detail in FIG. 5.

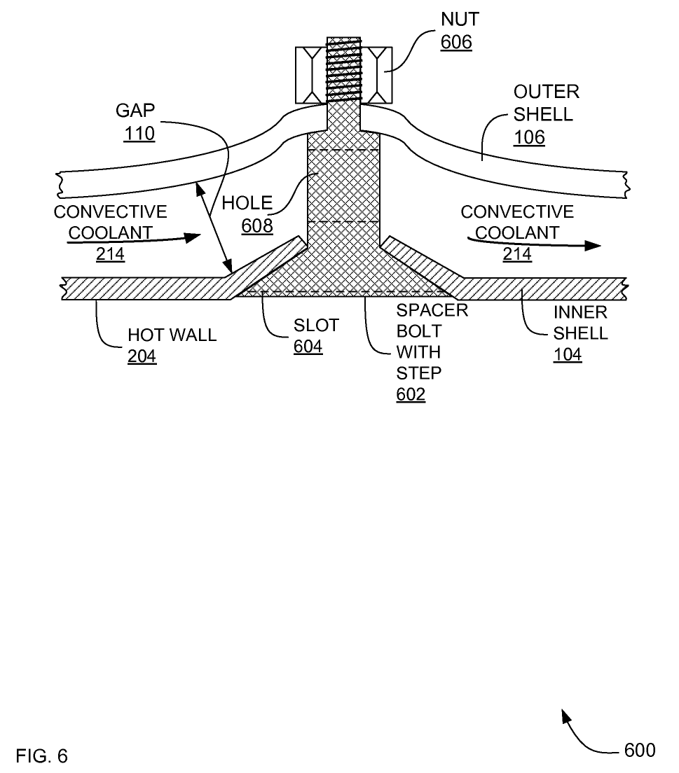

Option 20, a spacer bolt arrangement to connect the inner shell 104 to the outer shell 106 to prevent collapse of the inner shell 104, as described in greater detail in FIG. 6 below.

Option 21: Hybrid and Solid propellant rockets: The thrust chamber 102 recirculation cooling system will most often be used to liquid bi-propellant rocket engines although it could be used in rocket systems utilizing any number of propellants. In addition, it can be used in hybrid and solid propellant rockets and rocket systems. Solid propellant rockets utilize propellant that is solid in form similar in consistency as an automobile tire. In hybrid rockets at least one of the propellants is a solid and at least one of the propellants is a liquid. In solid propellant rockets, additional tankage, plumbing, and valves can be added to deliver the convective coolant 214 and internal film coolant 210 to the solid propellant rocket's thrust chamber. The same can be added to a hybrid propellant rocket unless the liquid propellant in the hybrid system can be used for either the internal film coolant 210 or the convective coolant 214 or both.

Option 22: Throat/Expansion Nozzle Plug: As an option to valve control and timing or more attach points (between the inner and outer shells) to prevent collapse of the inner shell 104 a plug can be put in or near the throat 121 or in the expansion nozzle 118. The plug would allow the combustion chamber 122 and/or complete thrust chamber 102 to be pressurized with gas to the point where the inner shell 104 will not collapse when the gap 110 is at full pressure before the engine has started. Upon engine start, the plug would be ejected from the engine whole or would break apart and then be ejected after which the thrust chamber 102 would be at a full operating pressure, and thus buckling of the inner shell 104 would be avoided.

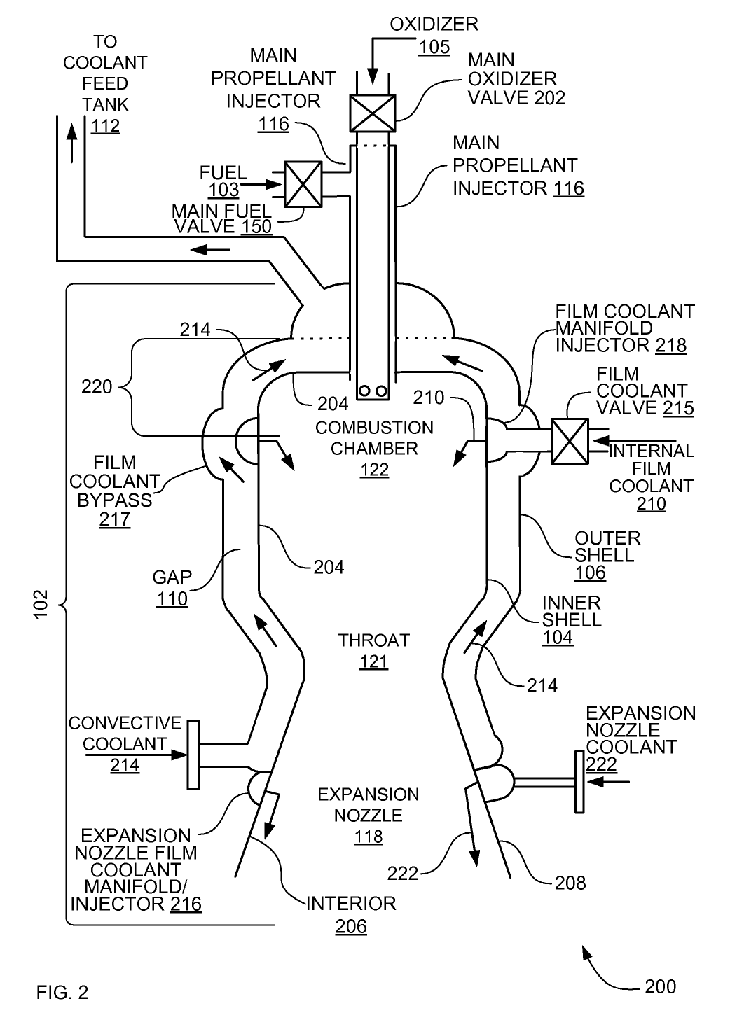

FIG. 2 is a cross section side-view block diagram of a propulsion system 200. Propulsion system 200 includes a rocket engine cooling system that does not require extensive machining, custom tooling and fabrication custom processes.

Propulsion system 200 includes a thrust chamber 102 having an outer shell 106 and an inner shell 104 with an inside wall 204. The thrust chamber 102 is the combination of the combustion chamber 122 and the expansion nozzle 118. The expansion nozzle 118 has an interior 206 and has an exterior 208. The inside wall 204 of the combustion chamber is also known as the “hot wall” or the “hot-gas-side” wall. The thrust chamber 102 outer shell 106 and inner shell 104 are thin metal structure that form the most significant, but not only, structural element that forms the thrust chamber.

The thrust chamber 102 is the portion of the rocket engine that is downstream of a main propellant injector 116 but also includes the thrust chamber dome 220. In some implementations, the main propellant injector 116 is a pintle injector as shown in FIGS. 1 and 2. The main propellant injector 116 is operably coupled to the thrust chamber 102. The main propellant injector 116 is also operable to inject a fluid of the main propellants (main fuel 103 and oxidizer 105) into the interior volume in the inside wall 204 of the thrust chamber 102 and in some implementations an internal film coolant 210 is injected and in some implementations the internal film coolant 210 is not injected. If the main propellant injector does not inject the internal film coolant 210 then that coolant can be injected by separate injector that injects only internal film coolant as shown in FIG. 2. The fluid main propellant includes oxidizer 105 and fuel 103. The fluid flowing into and through the thrust chamber includes the oxidizer 105, fuel 103 and any additional cooling fluids and internal film coolant 210. The internal film coolant 210 is often known as “coolant A.” The main propellants (main fuel 103 and oxidizer 105) can be a mono-propellant, or a plurality of main propellants.

When injected, the internal film coolant 210 spreads into a thin film on the inside wall 204. The function of internal film coolant 210 is two-fold: 1) to absorb heat directly as a coolant, thus reducing heat flow to the inner chamber wall (and reducing wall temperature), and 2) to deposit carbon in the form of “carbon black” or soot on the inner surface of the thrust chamber 102 (i.e. a process called “coking”), the soot being an insulator with very low thermal conductivity and will greatly reduce the amount of heat that flows through the thrust chamber 102 (and into the convective coolant 214 described below). The internal film coolant 210 can also be a non-coking fluid which absorbs heat but does not deposit carbon.

The main propellant injector 116 is similar to a showerhead that sprays liquid propellants, such as an oxidizer 105 of liquid oxygen and a fuel 103 of jet fuel, into the combustion chamber 122 where the oxidizer 105 and fuel 103 are burned. After combustion, the burned propellants expand in the expansion nozzle 118 where the burned propellants increase to high velocity and produce thrust. The internal film coolant 210 provides protection from excessive heat by introducing a thin film of coolant or propellant through orifices around the injector periphery or through manifolded orifices (as shown in FIG. 2 and FIG. 5) in the thrust chamber inside wall near the main propellant injector 116 or chamber throat region 121 or anywhere else in the thrust chamber 102 where internal film coolant is needed or desired.

In addition to the main propellant injector 116, propulsion system 200 includes a thrust chamber 102 having an outer shell 106 and an inner shell 104 with a convective coolant 214 flowing between the two shells in a gap 110. The convective coolant 214 is often known as “coolant B.”

Propulsion system 200 also includes an expansion nozzle film coolant manifold injector 216 that is operably coupled to the expansion nozzle 118. The injector 216 is operable to inject the convective coolant 214 in the interior 206 of the expansion nozzle 118 as a film coolant.

A film coolant bypass 217 is included to circumscribe a film coolant manifold 218. A dome 220 is a double shell dome as the baseline configuration of the systems, methods and apparatus as shown in FIG. 2. The flanges shown in FIGS. 2 and 5 are only example connection points and can be any connection method that is compatible with the required flow rate, temperature, and pressure.

As shown in FIG. 1 and FIG. 2, convective coolant 214 starts flowing in the gap 110 between the thrust chamber 102 inner shell 104 and outer shell 106 starting at the expansion nozzle 118 at any area ratio, but an area ratio of 2 or 3 can be considered typical. The convective coolant flows to the thrust chamber 102 due to pressure in the coolant feed tank 112 (FIG. 1). Flow of convective coolant 214 is initiated by opening the coolant isolation valve 124 and the pressure isolation valve 136 and by starting the recirculation pump 108. When the convective coolant 214 enters the thrust chamber 102 gap 110 at an entry point 142, of the thrust chamber 102, the convective coolant 214 flows upward until the convective coolant reaches the top of the combustion chamber 122, after which the convective coolant 214 exits from the gap at exit point 146 and then is pumped back to the coolant feed tank 112 for reuse again as a convective coolant 214 or as an expansion nozzle film coolant 222. Some of the convective coolant 214 is directed downward to the expansion nozzle 118, as in FIG. 1, where the convective coolant 214 (water as an example) is injected into the nozzle as an internal film coolant or as a dump coolant to cool that portion of the expansion nozzle 118 not cooled by the convective coolant 214 flowing between the outer shell 106 and inner shell 104, the baseline expansion nozzle 118 being made of a single shell downstream of the convective coolant/film coolant injection point.

The outer shell 106 and inner shell 104 of the thrust chamber 102 can be secured directly or indirectly to each other at their two ends (e.g. top and bottom ends) or the two shells can be secured to each other at many points throughout the surface area using any means helpful including bolts, screws, rivets, welds, brazing, or any other means. In addition, spacers and/or ribs of any configuration can be built into or added to the shells anywhere to maintain proper shell spacing and/or to ensure sufficient shell structural characteristics.

To strengthen the thrust chamber structure, the outer surface of the outer shell 106 can be overwrapped with filament winding or other composite material including, but not limited to graphite/epoxy, Kevlar/epoxy, glass/epoxy, metal wire/epoxy, and others including nonepoxy based composites.

The shell(s) can be fabricated using conventional methods of shell fabrication. The shell has sufficient strength and heat conductivity needed to conduct heat to the external convective coolant without overheating and/or failure. Methods of shell construction include, but are not limited to, spinning, welding, stamping, punching, extruding, explosive forming, drawing, plasma spraying, electroplating, brazing, riveting, and other methods.

As an option for construction of the thrust chamber 102, the thrust chamber can be fabricated in a similar way to a conventional regeneratively cooled thrust chamber: with numerous parallel coolant tubes brazed, electroplated, welded, or soldered together (or other methods) with or without a metal jacket or filament overwrapping on the exterior surface. Or, the thrust chamber 102 can be fabricated like another type of regeneratively cooled thrust chamber using cooling channels as opposed to tubes and fabricated using electroplating, plasma spraying, or other methods.

A top portion of the combustion chamber 122 is known as a dome 220. The dome shown in system 200 is a double-walled thrust chamber dome 220 with water (i.e. convective coolant) flowing between the two walls of the double-walled dome 220 and cooling the dome 220. The water flows from the gap between the outer and inner shells 106, 104 of the combustion chamber below to the interior of the double-shell of the dome and then it is pumped back to the coolant feed tank 112. The dome 220 can either be a simple double-shell where both walls (or shells) of the dome 220 are unattached to each other (except at the ends), or the two walls can be attached to each other with rivets, bolts, welding, brazing, electroplating, or plasma spraying, or any other process. The dome 220 can also have coolant flow channels fabricated or installed into the dome 220, or no channels at all. In applications where it is running cool enough the dome 220 can also be a single shell structure without any additional cooling mechanism.

The proportions of the internal film coolant 210 and convective coolant 214 provide for a high degree of thrust while maintaining relatively low temperatures in the thrust chamber 102. Cooling of the thrust chamber is accomplished while sustaining acceptably low values of losses to thrust. The combination of sufficiently high thrust and low temperatures avoids the need for a large number of expense expensive individual coolant tubes that are difficult to manufacture as is in conventional regeneratively cooled rocket engines. The technology of the systems, method and apparatus disclosed herein greatly simplifies and expedites fabrication of the thrust chamber 102 using conventional and simple fabrication techniques, such as fabrication techniques that might include but are not limited to spinning, winding, stamping, welding, brazing, rolling, explosion forming, welding, and others.

In one example, the thrust chamber 102 can be manufactured using the following process:

1.) Select shell material for both inner shell 104 and outer shell 106.

2.) Anneal the shell material.

3.) Spin shell material into appropriate geometries including the dome, cylindrical section of the combustion chamber, the conical section, and the expansion nozzle.

4.) Anneal the spun shell components again.

5.) Machine the internal film coolant manifolds.

6.) Weld thrust chamber shell components together. Install spacers and/or stiffeners as required.

7.) Grind off excess weld and heat treat shell structure as required.

In addition, the lower temperatures in the thrust chamber 102 avoid the need for thick walls of the thrust chamber. Thus systems 100 and 200 provide a simple thin metal shell structure as a thrust chamber 102, as shown in FIG. 1 and FIG. 2.

System 200 provides a low-cost fluid cooled rocket thrust chamber 102 that is easy to fabricate. System 200 includes a greatly simplified light-weight, fluid-cooled thrust chamber 102 that can be used in conjunction with any kind of rocket engine main propellant injector 116, and a very wide range of rocket engine thrust sizes and propellant combinations.

In one example, the amount of internal film coolant 210 that is introduced or injected into the inside wall 204 of the thrust chamber 102 is typically in a range of about 1% to about 5% of the total fluid flow to the engine (i.e. the ‘fluid’) but other values can be used. In another example, the amount of internal film coolant that is introduced or injected into the inside wall 204 of the thrust chamber 102 is about 2.5% of the fluid. In yet another example, the amount of internal film coolant that is introduced or injected into the inside wall 204 of the thrust chamber 102 is about 3.5% of the fluid. In yet a further example, the amount of convective coolant 214 that is introduced or injected into the interior 206 of the expansion nozzle 118 is typically will fall in a range of 1% to 6% of the fluid but other values can be used. In still yet another example, the amount of internal film coolant that is introduced or injected into the inside wall 204 of the thrust chamber 102 is about 3.5% of the fluid and the amount of convective coolant 214 that is introduced or injected into the interior 206 of the expansion nozzle 118 is about 3.0% of the fluid. Typical expected values for both the internal film coolant 210 and the convective coolant 214 can be 3.5% and 3.0% of total fluid flow respectively.

The thrust chamber inside shell wall 204 is also known as a “hot wall” because the heat of the combustion is generated inside of the thrust chamber 102. More specifically, the heat of combustion is generated inside of the combustion chamber 122.

In FIG. 2, cooling of the expansion nozzle 118 is accomplished as follows: A portion of the convective coolant 214 flow rate is then injected as a film coolant along the hot wall of the expansion nozzle 118 or as a dump coolant in order to cool the expansion nozzle 118. The film coolant valve 215 can be branched off the convective coolant line either upstream of the coolant isolation valve 124 or downstream of the thrust chamber 102 upstream of the heat exchanger 138 or anywhere else in the convective coolant system that the designer wishes. Another option is to eliminate the film coolant valve 215 and simply have the nozzle film coolant feed off of the lower coolant manifold 137, or is fed from its own tube that branches off downstream of the coolant isolation valve 124. Because the expansion nozzle 118 is of low static pressure as compared to the combustion chamber 122, on the order of 10-30 times less, the pressure and boiling point ranges of the convective cooling system available with which the propulsion system 200 can be manufactured and operated are very broad. Therefore, pressure of the convective coolant 214, and in turn, heat absorbing capacity of the convective coolant 214, can be selected to optimize the amount of convective coolant 214 for a given type of engine. The broad range of the pressure of the convective coolant 214 at which the propulsion system 200 can be manufactured for and operated at provides a variety of operating scenarios such as increasing the convective coolant 214 system pressure in order to increase the heat absorbing capacity and thus decrease the amount of convective coolant 214 that is required, or of decreasing the convective coolant 214 system pressure to decrease the tankage and pressurant gas weight of the convective coolant 214 in a “pressure-fed” rocket system or to decrease pumping horsepower requirements (if a system that uses a pump to pressurize the convective coolant is used). Cooling the nozzle as described in FIG. 2 simplifies the design of a nozzle extension. The nozzle extension is the portion of the expansion nozzle 118 that is downstream of the injection point of the convective coolant 214 in the expansion nozzle 118. In the example of FIG. 2, the nozzle extension is fabricated as a single shell of a simple thin sheet metal or a metal or plastic composite material.

The pintle injector implementation of the main propellant injector 116 that is shown in FIGS. 1, 2, and 5 was originally developed by TRW in the early 1960's. The dome 220 of a propulsion system using a pintle injector is the top of the thrust chamber 102. The dome 220 in FIG. 2 is a double walled metal shell with convective coolant flowing between the two walls similar to the rest of the thrust chamber 102. A single walled dome with no convective coolant flowing in it can be used if it is made of the appropriate material and that portion of the combustion chamber is operating at low enough temperatures (not always the case for every type of engine). The dome 220 of FIGS. 1, 2, and 5 can be dome-shaped, conical, flat, or other geometries.

An alternative to using a pintle main propellant injector in a rocket engine is to use a flat-face main propellant injector similar to the main propellant injectors of the SSME, J-2, and F-1 liquid bi-propellant rocket engines. A flat-faced main propellant injector is just like the name implies, it is a metallic structure with a flat side to it (i.e. the ‘face’) that has holes in it for injecting the main propellants, the main fuel 103 and main oxidizer 105, into the combustion chamber where they are burned. Overall, a flat-face injector looks similar to many bathroom showerheads. In addition to injecting the main propellants the flat-face injector can have a ring of small holes or slots around a periphery of the flat-face injector to inject film coolant along the combustion chamber hot-wall. Or, the film coolant can be injected from a separate manifold/injector of the film coolant as shown with a pintle injector in FIG. 2. The main propellants can be a mono-propellant, or a plurality of main propellants.

With this type of engine design utilizing a flat-face main propellant injector, the thrust chamber cooling system is similar to that of the previously described cooling system for the pintle injector engine with the exception that there is no thrust chamber dome 220 to cool with the convective coolant. However, such flat-face injector rocket engines can include a propellant dome or an oxidizer dome at the top of the thrust chambers. The propellant dome or oxidizer dome can have the effect of directing propellant (usually the oxidizer) to a main propellant injector and are not included in the thrust chamber 102 in a location or a position that exposes the propellant directly to hot combustion gases. Such structures are not confused with a thrust chamber dome 220. The propellant can be a mono-propellant, or a plurality of propellants.

The systems, methods and apparatus described herein are not limited by particular implementations. For example, variations of the thrust chamber 102, which can include any of variety of geometries of combustion chamber 122 including the conventional cylindrical combustion chambers or spherical combustion chambers, such as in the German WW2 V2 rocket engine.

In other examples of non-limiting variations, the convective coolant 214 can flow in the either the “up” or “down” directions. More specifically, as shown in FIGS. 1, 2, and 5, the convective coolant flow in the gap can begin at the expansion nozzle 118 and flow upwards towards the main propellant injector 116 (i.e. counter-current flow), or it can begin flowing near the injector-end of the engine and flow downward towards the expansion nozzle 118.

In other examples of non-limiting variations, the convective coolant 214 is circulated in the gap between the outer and inner shells 106, 104 in a liquid state, as a boiling liquid (two phase fluid), or in a gaseous state (as a gas or vapor), or in any combination of these three fluid states.

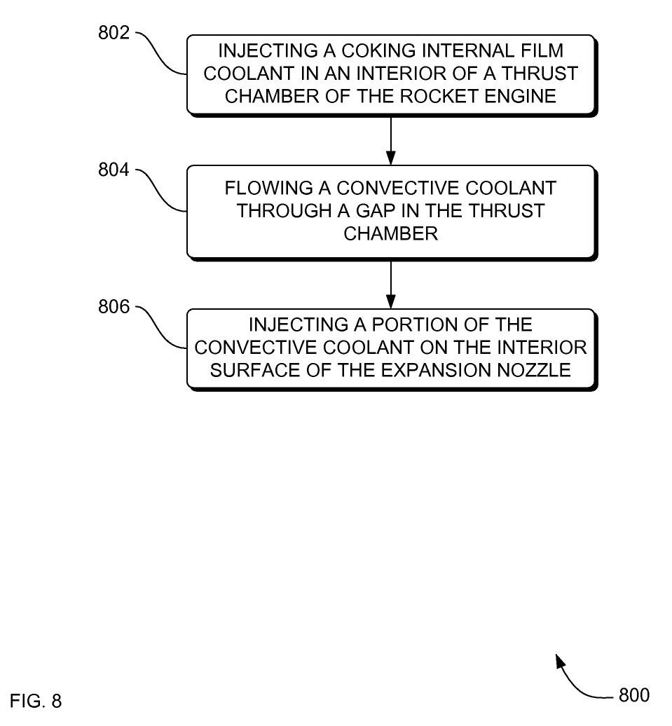

In other examples of non-limiting variations, either or both of the internal film coolant 210 and the convective coolant 214 can be different types of fluid than those that make up the main propellants (main fuel 103 and oxidizer 105). In one aspect briefly described in FIG. 1, dual coolants are used for the internal film coolant 210 and the convective coolant. For example, in a liquid oxygen/hydrogen engine, the internal film coolant 210 can be one of many different coking fluids, and the convective coolant 214 can be hydrogen, water or other non-coking fluid, that is the convective coolant is non-coking at the maximum temperature is achieves when in the gap 110. The dual coolants are described in greater detail in conjunction with FIG. 8 below. The main propellants can be a mono-propellant, or a plurality of main propellants.

While the system 200 is not limited to any particular thrust chamber 102, inside wall 204, combustion chamber 122, expansion nozzle 118, expansion nozzle interior 206, expansion nozzle exterior 208, main propellant injector 116, oxidizer 105, fuel 103, main fuel valve 150, main oxidizer valve 202, film coolant valve 215, internal film coolant 210, outer shell 106, inner shell 104, a convective coolant 214 and an expansion nozzle film coolant manifold injector 216, film coolant bypass 217, thrust chamber dome 220, for sake of clarity a simplified thrust chamber 102, inside wall 204, combustion chamber 122, expansion nozzle 118, expansion nozzle interior 206, expansion nozzle exterior 208, main propellant injector 116, oxidizer 105, fuel 103, main fuel valve 150, main oxidizer valve 202, film coolant valve 215, internal film coolant 210, outer shell 106, inner shell 104, a gap 110, an convective coolant 214, expansion nozzle film coolant, and an expansion nozzle film coolant manifold injector 216, film coolant bypass 217, thrust chamber dome 220 are described.

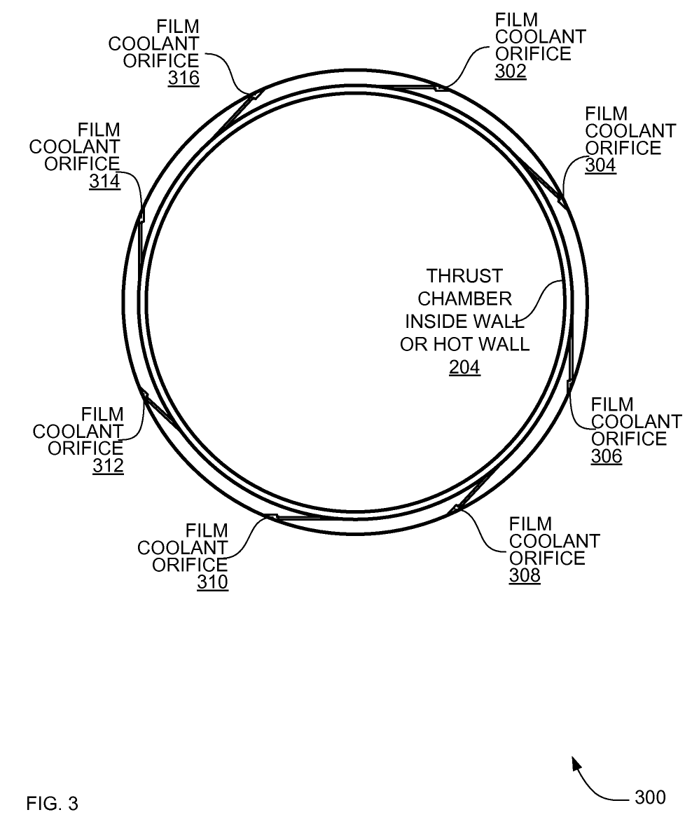

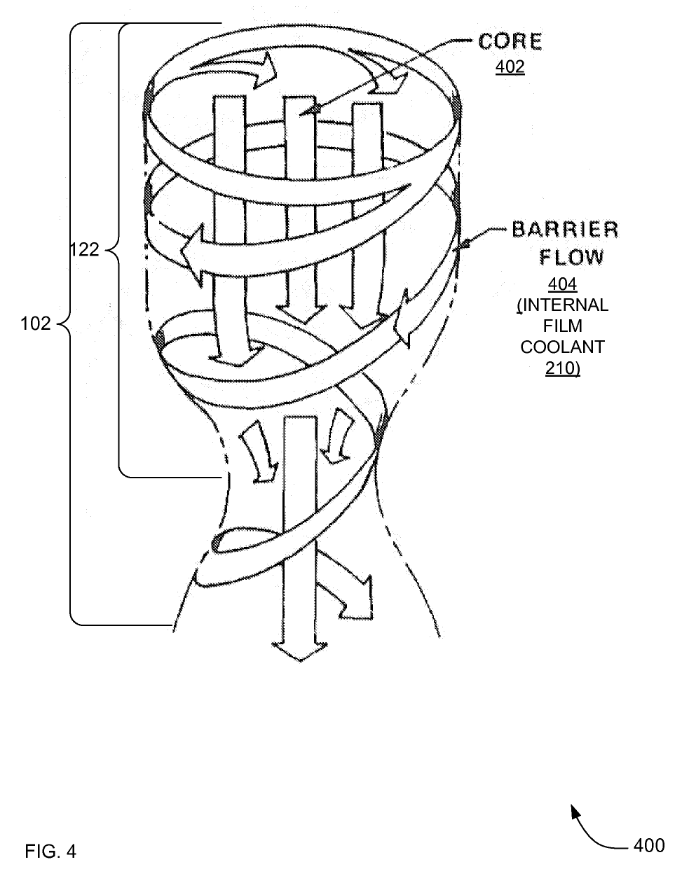

FIG. 3 and FIG. 4 show examples of a vortex injection pattern for internal film coolant film injection onto a hot chamber wall. Other patterns and methods for injecting internal film coolant are also possible.

FIG. 3 is a cross section top-view block diagram of combustion chamber apparatus 300 having film coolant orifices. Apparatus 300 helps provide for a lightweight rocket engine of any size while using low-cost fabrication methods and inexpensive, non-exotic materials. Thus, apparatus 300 simplifies and expedites the production of a fluid-cooled rocket engine thrust chamber 102. Apparatus 300 helps solve solves the need in the art for a thrust chamber made of less expensive materials and manufacturing processes.

Apparatus 300 includes one or more film coolant orifices that inject a internal film coolant fluid onto the inside wall of a thrust chamber 102. In some implementations, the fluid is convective coolant 214 that is injected into the interior 206 of the expansion nozzle 118. Apparatus 300 includes eight film coolant orifices 302, 304, 306, 308, 310, 312, 314 and 316. However the orifices can be any geometry, number, size, or orientation, and can be located any where in the thrust chamber where coolant is needed. The internal film coolant fluid can be any coking fluid or non-coking fluid.

The injection of the fluid through the orifices and onto the inside wall of the thrust chamber 102 maintains the inside wall at modest temperatures, such as temperatures below 1300 degrees Fahrenheit. Temperatures below 1300 degrees Fahrenheit do not require exotic, rare, or expensive materials. Instead, low-cost and readily available materials that maintain their strength at low-to-medium temperatures (below 1300 degrees Fahrenheit) can used for the thrust chamber. For example, the thrust chamber can be made of aluminum, steel, stainless steel, Inconel®, copper, bronze, alloys thereof, mixtures thereof, and metal composites and plastic composites. In some implementations, the thrust chamber can be made of aluminum, stainless steel, Inconel®, alloys thereof and mixtures thereof. In some implementations, the thrust chamber can be made of Inconel. Inconel® is a registered trademark of Special Metals Corporation of New Hartford, N.Y., referring to a family of austenitic nickel-based superalloys.

The relatively low temperatures in the thrust chamber 102 also allows for a thrust chamber having a shell wall thickness typically (but not always) of between about 0.020 inches and about 0.090 inches. Other thicknesses can be used as well. In some implementations, the thrust chamber wall thickness is between about 0.06 and about 0.07 inches. In some implementations, the thrust chamber wall thickness is about 0.030 inches.

The thrust chambers of FIG. 1 and FIG. 2 are less elaborate than conventional fluid cooled chambers, and operate at low-to-medium inner surface temperatures on the inside wall 204 (i.e. below about 1300 degrees Fahrenheit), approximately the exhaust temperature of high-performance internal combustion automotive engines, so that low-cost materials which can have low strength at elevated temperatures (i.e. above 1300 degrees Fahrenheit) can be used in the composition of the thrust chamber 102. Thus, the thrust chamber 102 is much easily produced by many more potential low-cost, low-overhead, commercial vendors that currently exist in industry.

FIG. 4 is an isometric block diagram of a thrust chamber 400 that shows a swirling flow of a layer of internal film coolant along the thrust chamber inside wall. In FIG. 4, internal film cooling fluid is injected tangentially into the combustion chamber of the thrust chamber 400. Core flow 402 from main propellants (main fuel 103 and oxidizer 105) is inside the swirling surface flow and parallel to the engine long axis. This method of internal film coolant injection is an example only since any injection method can be used so long as the coolant is distributed over those areas requiring film coolant. The main propellants can be a mono-propellant, or a plurality of main propellants.

In comparison, tangential injection of fluid shown in FIG. 3 creates a swirling flow 404 (FIG. 4) of the internal film coolant 210 layer against or along the thrust chamber inside wall 204. The swirling flow 404 can also be described as a vortex flow resulting from the injection method shown in FIG. 3.

As an alternative to cooling the thrust chamber dome with wrapped coiled external coolant tubes or a double wall dome, the dome can be cooled with a conventional ablative material mounted to the inside surface of the dome. In another option the thrust chamber dome can be transpirationally cooled (as in conventional transpiration cooling), or the thrust chamber dome can be uncooled if the main propellant injector 116 causes the steady-state temperature of the dome to be low enough to operate without a cooling system.

FIG. 5 is a cross section side-view block diagram of an alternative configuration of a propulsion system engine 500 having a shell and a spiraled coolant tube instead of a gap between two shells. FIG. 5 shows a thrust chamber 102 cooling system arrangement in which instead of having an inner shell 104, outer shell 106, and gap 110, a single shell 502 is included. Engine 500 has one or more external convective coolant tubes 504 wrapped around the shell. The convective coolant tube 504 can be brazed, soldered, welded or bonded to the shell 502 by other means. The dome 220 is a double shell dome as the baseline configuration of the systems, methods and apparatus described herein but can also be a single shell with a convective coolant tube 504 wrapped around the single shell and bonded to the single shell, as shown in FIG. 5. Although somewhat different than the double shell configuration with a gap 110, the propulsion system 500 functions in the same way in that convective coolant flows through the convective coolant tube(s) 504 instead of a gap 110. Like the double shell configuration (sometimes called double wall configuration), the single shell/tube configuration utilizes optional internal film coolant 210. A film coolant bypass 217 is included in the coolant tubes 504 to circumscribe a film coolant manifold 218.

Although FIG. 5 shows a single convective coolant tube 504, in other examples of non-limiting variations, the one or more coolant tube(s) 504 wind around the thrust chamber 102; two, several, or more coolant tube(s) 504 can be wound around the thrust chamber 102 in parallel to each other; or, alternatively, a small number of stacked tubes (toruses) can be connected together by two (or a few) vertical manifolds providing inlet(s) and outlet(s) for each ring. In other examples of non-limiting variations, each of the coolant tube(s) 504 flow convective coolant 214, and the coolant tubes 504 are bonded in place using soldering, welding, brazing, or other methods. The exact number and configuration of one or more coolant tube(s) 504 are various.

In other examples of non-limiting variations, the one or more coolant tube(s) 504 of FIG. 5 can be of any material, wall thickness, or geometry in cross-section as long as the coolant tubes transfer the heat that flows through the thrust chamber 102 to the convective coolant 214. Other implementations of the coolant tubes 504 include copper, stainless steel, Inconel, steel, aluminum, and nickel or alloys of all of these materials or other materials. In other examples of non-limiting variations, the cross-section geometry of the coolant tube(s) 504 can be circular, square, octagonal, hexagonal, round on one side and flat on the other, oval, or any other geometry that will carry fluid.

In FIG. 5 the external coolant tube(s) can be any geometry, material, or wall thickness so long as the tube(s) can adequately absorb the heat being conducted through the wall of the thrust chamber.

An option to FIGS. 1, 2, and 5 is that the convective coolant convective and internal film coolants can, be modified with any type of additives. Variations can include, but are not exclusive to, changing the boiling or freezing points of the fluids or the viscosity of the fluids or other properties.

In other examples of non-limiting variations of the propulsion system of FIG. 5, the one or more coolant tube(s) 504 are modified to be a half-tube, as opposed to the full perimeter tube, that is bonded (i.e. soldered, brazed, welded, or other attachment method) to the thrust chamber 102 exterior wall. The half-tube is a coolant tube 504 tube that has been split in half along length of the coolant tube 504 and is wound around the thrust chamber 102 in the same manner as a full diameter coolant tube(s) 504. Like a full tube, the half-tube can be of any cross-sectional geometry so as long as coolant tube 504 transfers allows the heat flowing through the thrust chamber 102 to be transferred to the convective coolant 214. The half-tube coolant tube 504 is bonded to the thrust chamber 102 with an open side facing the thrust chamber 102, thus forming a flow passage for convective coolant 214. Any cross-sectional geometry of coolant tube can be used including but not exclusive to a circle, square, rectangular, round on one side and flat on the other, octagonal, hexagonal, and others, or any combination of these and others.

FIG. 6 is a cross section side-view block diagram of a sample bolting arrangement for securing the inner and outer shells together. FIG. 6 shows an example spacer bolt arrangement that could be used to connect the inner shell 104 to the outer shell 106 to prevent collapse of the inner shell 104. This bolting arrangement is only an example arrangement so other bolting arrangements can be used. In the bolting configuration of FIG. 6 the spacer bolt 602 is made of a strong yet highly conductive material such as an alloy of copper or nickel. The inner shell 104 and outer shell 106 are both dimpled to maintain a constant gap 110 width and to ensure that the bolt head is flush with the hot-wall on the inside of the thrust chamber 102. For larger size spacer bolts 602 an optional hole 608 of any shape can be fabricated through the bolt to allow convective coolant 214 to better cool the spacer bolt 602. The spacer bolt 602 has a step fabricated into it to maintain the gap 110 at constant width. The spacer bolt 602 can be have an optional slot 604 or any other kind of keying mechanism or no keying mechanism. If a slot 604 is used then it should be oriented parallel to the hot gas flow inside the thrust chamber 102. A nut 606 is sealed with braze, solder, welding, adhesives, polymers, or by other means. As an option the nut 606 can be sealed with an o-ring or gasket instead of the means listed above. When this is used with a slightly oversized hole in the outer shell 106 it allows the outer shell 106 to move slightly relative to the inner shell 104 to allow relative movement of the two shells when the inner shell 104 thermally expands due to heating. Washers can be used with the nut 606 when deemed helpful. To assist in accommodating thermal expansion differences between the inner shell 104 and outer shell 106, the outer shell 106 can have an expansion joint(s) installed into it such as a bellows or other expansion joint. Bolts as in FIG. 6 or any other connective device that joins the inner shell 104 and outer shell 106 can be used to prevent collapse of the inner shell 104. In addition to direct pressure effects they can also resist buckling due to static pressure head of the fluid in the gap, acceleration effects especially for upper state engines, and for the drop in static pressure incurred near the throat 121 and in the expansion nozzle 118 after the engine has started.

### Method Implementations

In the previous section, apparatus of the operation of an implementation was described. In this section, an implementation of a particular method is described by reference to a flowchart.

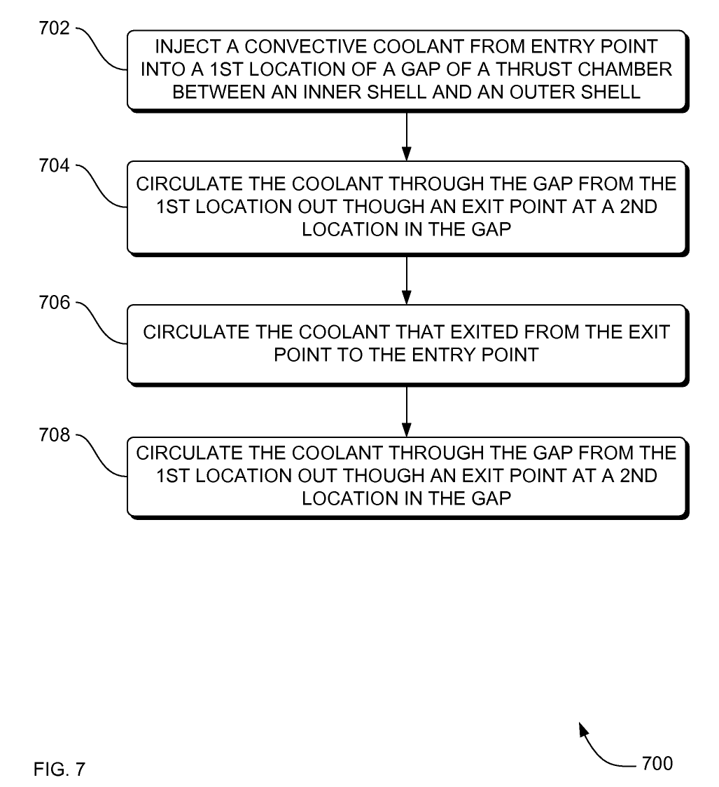

FIG. 7 is a flowchart of a method 700 to cool a rocket engine through recirculation of a convective coolant. In method 700, a convective coolant is circulated at least twice through a gap 110 between an inner shell 104 of a thrust chamber 102 and an outer shell 106 of the thrust chamber 102.

Method 700 includes injecting a convective coolant from entry point into a first location of the gap 110 of the thrust chamber 102 between an inner shell 104 and an outer shell 106, at block 702.

Method 700 also includes circulating the convective coolant through the gap 110 from the first location out though an exit point at a second location in the gap 110, at block 704.

Method 700 also includes circulating the convective coolant that exited from the exit point to the entry point, at block 706. The circulating 706 is performed through a passage other than the gap 110, such as the recirculating convective coolant loop 114 in FIG. 1.

Method 700 also includes circulating the convective coolant through the gap 110 from the first location out though an exit point at a second location in the gap 110, at block 708.

FIG. 8 is a flowchart of a method 800 to cool a rocket engine according to an implementation. Method 800 includes injecting an internal film coolant in an interior of a thrust chamber of the rocket engine, at block 802.

Some implementations of method 800 also include circulating a convective coolant 214 through a gap 110 in the structure of the thrust chamber 102 of the rocket engine, at block 804.

Method 800 also includes injecting the convective coolant 214 in an interior of the expansion nozzle 118, at block 806. The internal film coolant 210 and the convective coolant 214 are injected in various proportions described in FIG. 1.

In one implementation briefly described in FIG. 1 above, dual coolants are used for the internal film coolant 210 and the convective coolant. “Coking” hydrocarbon internal film coolant 210 flows on the inner wall surface 204 (the hot wall side) of the thrust chamber 102 and a convective coolant 214 flows in a gap 110 between an inner shell 104 and an outer shell 106. In some implementations, the internal film coolant 210 minimizes the amount of convective coolant 214 required.

In addition to flowing through the gap 110 in the thrust chamber 102 a portion of the convective coolant 214 is released, along the inside surface of the expansion nozzle 118 where the convective coolant 214 cools the expansion nozzle 118 as a film coolant or as a dump coolant or both. In dump cooling the expansion nozzle 118 or a portion of the expansion nozzle is built as a double shell structure with a gap that is open at the bottom. Convective coolant flows in the gap 110, cools the expansion nozzle 118, and is ‘dumped’ out the bottom after it has performed its cooling function. An alternative for dump cooling would be to build the expansion nozzle 118 or expansion nozzle extension as a single shell structure with a coiled tube (s) around it as in FIG. 5. In this case the tube(s) would ultimately ‘dump’ their coolant as would the double shell structure described above.

In one implementation the dual coolants include a coking, hydrocarbon internal film coolant 210, (usually a fuel as listed below) that absorbs heat, and that in turn, decreases the amount of heat that is absorbed by the thrust chamber 102 by carbon deposition and heat absorption. The heat that is absorbed by the thrust chamber 102 is then absorbed by the convective coolant 214, that flows in the gap 110.

In other examples of non-limiting variations, a coking or hydrocarbon internal film coolant 210 is a fuel such as jet fuel (like Jet-A or JP-4), kerosene and kerosene-based fuels, rocket fuel (such as RP-1), propane, butane, and/or liquid or gaseous methane or others. In that variation block 802 of method 800 includes spraying a certain amount of coking internal film coolant 210 against the inside (hot) wall 204 surface of the rocket engine thrust chamber 102 downstream or upstream of the main propellant injector 116. The flow rate of coking internal film coolant 210 is approximately 1 to 5 percent of the total fluid flow to the propulsion system, including the main propellants (main fuel 103 and oxidizer 105) that can flow through the main propellant injector 116. The amount of internal film coolant 210 can vary beyond the range of 1 to 5 percent. The deposition of carbon is a result of the decomposition of coking internal film coolant 210 by the heat that the coking internal film coolant absorbs from the propellant burning within the thrust chamber 102. The internal film coolant 210 can be injected into the thrust chamber 102 in either the liquid, boiling, or gaseous states as long as the coking internal film coolant 210 deposits carbon on the inside 204 hot-side surface of the thrust chamber 102.

The reduction of heat flow that results from the deposition of carbon from the internal film coolant 210 means that less heat will flow through the thrust chamber 102 and less convective coolant 214 flow rate will be required in the gap 110 of the thrust chamber 102 to absorb it. Thus a coking hydrocarbon (carbon depositing) internal film coolant 210 film coolant results in less required convective coolant 214, that in turn results in a more efficient engine that produces higher thrust for a given total fluid flow rate to the rocket engine (i.e. propellant flow rate plus coolant flow rate). The coking internal film coolant 210 also provides a simple, low-cost construction and materials as described above. The coking internal film coolant 210 can be injected into the thrust chamber 102 using orifices arranged in a vortex pattern (see FIGS. 3 and 4), injected parallel to the inner wall of the thrust chamber 102, injected perpendicular to the thrust chamber hot-gas-side wall, or injected at an angle to the hot-side wall. To inject the coking internal film coolant 210, any number, geometry, size, or orientation of orifices can be used. The coking internal film coolant 210 can also be injected in the thrust chamber 102 at as many film coolant injection stations or rings as desired. The exact orientation, geometry, or number of internal film coolant 210 injection orifices is not critical so long as the internal film coolant 210 deposits the appropriate amount of carbon in the appropriate areas of the thrust chamber 102. In some implementations, the internal film coolant 210 is dispersed along the inside 204 hot-wall surface of the thrust chamber 102. The injection options for the internal film coolant 210 are also valid for the expansion nozzle film coolant 222.

The heat that gets through the carbon layer deposited by internal film coolant 210 and thus through the thrust chamber 102 is absorbed by convective coolant 214 that is flowing through the gap 110 between the outer shell 106 and inner shell 104 of the thrust chamber 102. In some implementations, the convective coolant 214 is one of any clean-evaporating noncoking fluids (i.e. non-coking at the temperature range when flowing in the gap 110 such as water, gaseous hydrogen, liquid hydrogen, propane, methane, or others. The requirement for the external convective coolant 214 is clean evaporation (i.e. does not deposit carbon within the one or more coolant tube(s) 504 when at the temperature range achieved when within the gap 110.) Deposition of carbon or other residue within the one or more coolant tube(s) 504 detrimentally reduces the flow rate of convective coolant 214 and reduces efficiency of the convective coolant 214 in absorbing the heat that gets through the thrust chamber 102, thus resulting in undesirably high thrust chamber 102 temperatures, high convective coolant 214 pressure drops, with attendant reduced flow rates, or both.

The function of internal film coolant 210 is to minimize the amount heat flowing through the thrust chamber 102 so the amount of convective coolant 214 that is required is also reduced. If the amount of convective coolant 214 is minimized then the overall performance of the engine will be increased.

In other examples of non-limiting variations, the convective coolant 214 is composed entirely of water that circulates in the gap 110. The water convective coolant 214 flows through the gap 110 upward from the expansion nozzle 118 to the top of the combustion chamber 122. When water external convective coolant 214 flows to the top of the combustion chamber 122 a number of options of flow are available depending on the exact configuration of the engine. In some examples, the water (convective coolant) is injected along the internal wall 206 (the hot-gas-side wall) as film coolant in a similar manner that the internal film coolant 210 is injected as film coolant higher up near the main propellant injector 116. However, in the propulsion system of FIGS. 1, 2, and 5 the convective coolant 214 is routed to the expansion nozzle 118 where it cools a portion of the expansion nozzle as film coolant.

Control of all cooling fluids will be implemented by sequencing valves to release and maintain the flow of cooling fluids to prevent overheating of engine components. Control of the sequencing valves for the cooling fluids is coordinated with timing and operation of the engine main propellant valves and igniter signals. Any method of sequencing of such valves common to or typical of control of rocket engines, such as the use of signals from the rocket vehicle flight computer, or from an independent engine control computer, or other sequencing electronics, can be used to control signals to the coolant control valve(s).

In some implementations, sufficient pressure is maintained in all coolant fluids so that flow of the coolant fluids is adequate to cool the engine for the operation of the engine during the flight. This pressure can be generated by a number of means, such as through pumps or pressurized gas systems.

The flow of engine coolant fluids can be controlled so that coolant is present when the engine generates heat that, in the absence of cooling fluid, can damage the engine. The flow of engine fluid coolants can be controlled by opening and closing valves that gate coolant flow to the engine. The cooling valves are turned ON and OFF at specific times so that A) coolant fluid is not wasted when not needed and 2) coolant flow prevents engine overheating.

Thus, the timed control of coolant valves are coordinated with the main engine valves that turn ON and OFF the flow of main propellant into the rocket engine, because the heat generated by the burning of the main propellants (main fuel 103 and oxidizer 105) are removed by the coolant to prevent engine overheating and damage. A conventional method of controlling the sequencing of these valves is to use a small engine control computer that is attached to the rocket. This engine control computer can be the flight computer, which also has overall control of the guidance, navigation and control of the rocket vehicle; or the engine control computer can be a dedicated engine control computer acting as a sequencing device.

One purpose of the engine control computer is to generate electrical control signal commands that can have at least two electrical control states: a high voltage (or current) state and a low state. Some signal-generating electrical systems can also generate intermediate states so that a continuous signal level, from low to high can be generated. These signals are sent from the computer to the valve actuators. A valve actuator is a mechanical device that generates force and motion in two different directions, depending on level of the electrical states the valve actuator receives from the computer. Thus the control states generated by the computer will have the effect of opening and closing the coolant valves.

In some implementations, the timing of the control signals to the coolant valves is controlled by a software program stored in the engine control computer. The engine control computer has the typical features of any computer, and others common to hardened industrial computers and flight computers on rocket vehicles, namely:

1) A computer application program (software) that is stored in a memory device in the engine control computer.

2) A method of generating the application program and transferring the application program into the engine control computer. In some implementations, the transfer is performed well in advance of operation of the engine.

3) Sufficient built-in hardware common to all computers, such as volatile memory, registers, program counters, etc, needed to support the operation of a stored program capable of executing the application program.

4) A stored program or set of instructions that can execute the application program.

5) Input and output (I/O) lines which are hardwired to the engine control computer that send low-current/low-voltage electrical signals to and from signal conditioners or amplifiers.

6) Signal conditioners or power amplifiers that adjust the amplitude of signals going to and from the engine control computer to controlled devices and external sensors so that these signals can be received by the engine control computer or external device.

7) Environmental hardening so that the engine control computer can withstand conditions typical of rocket flight, including vibration, elevated temperatures, and vacuum conditions.

8) A communications line leading from outside the rocket vehicle to the engine control computer so that external countdown procedures on the ground can trigger the initiation of the applications program. This can be as simple as a single I/O line or can be a serial or parallel line that communicates to ground control.

The application program generates state outputs to the cooling system valves so that cooling fluid flows and prevents excessive temperatures from occurring in the engine.

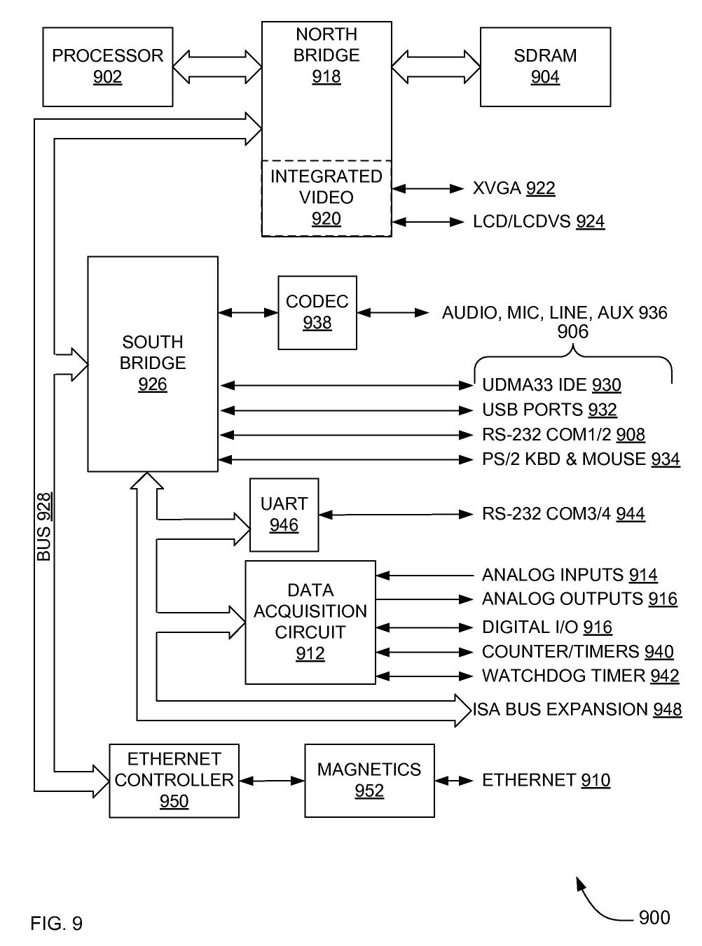

In some implementations, method 800 is implemented as a computer data signal embodied in a carrier wave, that represents a sequence of instructions which, when executed by a processor, such as processor 904 in FIG. 9, cause the processor to perform the respective method. In other implementations, method 800 is implemented as a computer-accessible medium having executable instructions capable of directing a processor, such as processor 904 in FIG. 9, to perform the respective method. In varying implementations, the medium is a magnetic medium, an electronic medium, or an optical medium.

### Hardware and Operating Environment

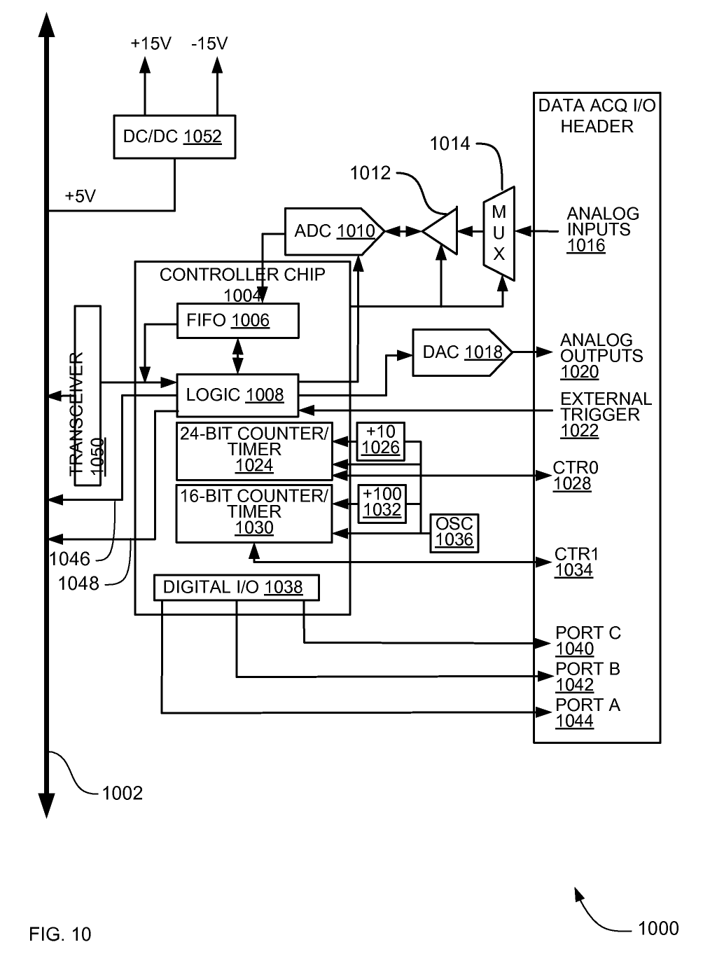

The description of FIG. 9 and FIG. 10 provides an overview of electrical hardware and suitable computing environments in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 9 is a block diagram of an engine control computer 900 in which different implementations can be practiced. The engine control computer 900 includes a processor (such as a Pentium III processor from Intel Corp. in this example) which includes dynamic and static ram and non-volatile program read-only-memory (not shown), operating memory 904 (SDRAM in this example), communication ports 906 (e.g., RS-232 908 COM1/2 or Ethernet 910), and a data acquisition circuit 912 with analog inputs 914 and outputs and digital inputs and outputs 916.

In some implementations of the engine control computer 900, the data acquisition circuit 912 is also coupled to counter timer ports 940 and watchdog timer ports 942. In some implementations of the engine control computer 900, an RS-232 port 944 is coupled through a universal asynchronous receiver/transmitter (UART) 946 to a bridge 926.

In some implementations of the engine control computer 900, the Ethernet port 910 is coupled to the bus 928 through an Ethernet controller 950.

With proper digital amplifiers and analog signal conditioners, the engine control computer 900 can be programmed to drive coolant control gate valves, either in a predetermined sequence, or interactively modify coolant flow by opening and closing (or modulating) coolant control valve positions, in response to engine or coolant temperatures. The engine temperatures (or coolant temperatures) can be monitored by thermal sensors, the output of which, after passing through appropriate signal conditioners, can be read by the analog to digital converters that are part of the data acquisition circuit 912. Thus the coolant or engine temperatures can be made available as information/data upon which the coolant application program can operate as part of decision-making software that acts to modulate coolant valve position in order to maintain the proper coolant and engine temperature.

FIG. 10 is a block diagram of a data acquisition circuit 1000 of an engine control computer in which different implementations can be practiced. The data acquisition circuit is one example of the data acquisition circuit 912 in FIG. 9 above. Some implementations of the data acquisition circuit 1000 provide 16-bit A/D performance with input voltage capability up to +/−10V, and programmable input ranges.

The data acquisition circuit 1000 can include a bus 1002, such as a conventional PC/104 bus. The data acquisition circuit 1000 can be operably coupled to a controller chip 1004. Some implementations of the controller chip 1004 include an analog/digital first-in/first-out (FIFO) buffer 1006 that is operably coupled to controller logic 1008. In some implementations of the data acquisition circuit 1000, the FIFO 1006 receives signal data from and analog/digital converter (ADC) 1010, which exchanges signal data with a programmable gain amplifier 1012, which receives data from a multiplexer 1014, which receives signal data from analog inputs 1016.

In some implementations of the data acquisition circuit 1000, the controller logic 1008 sends signal data to the ADC 1010 and a digital/analog converter (DAC) 1018. The DAC 1018 sends signal data to analog outputs. The analog outputs, after proper amplification, can be used to modulate coolant valve actuator positions. In some implementations of the data acquisition circuit 1000, the controller logic 1008 receives signal data from an external trigger 1022.

In some implementations of the data acquisition circuit 1000, the controller chip 1004 includes a digital input/output (I/O) component 1038 that sends digital signal data to computer output ports.

In some implementations of the data acquisition circuit 1000, the controller logic 1008 sends signal data to the bus 1002 via a control line 1046 and an interrupt line 1048. In some implementations of the data acquisition circuit 1000, the controller logic 1008 exchanges signal data to the bus 1002 via a transceiver 1050.

Some implementations of the data acquisition circuit 1000 include 12-bit D/A channels, programmable digital I/O lines, and programmable counter/timers. Analog circuitry can be placed away from the high-speed digital logic to ensure low-noise performance for important applications. Some implementations of the data acquisition circuit 1000 are fully supported by operating systems that can include, but are not limited to, DOS™, Linux™, RTLinux™, QNX™, Windows 98/NT/2000/XP/CE™, Forth™, and VxWorks™ to simplify application development.

### CONCLUSION

An economical liquid-fueled propulsion system is described. A technical effect of the system is sufficiently high thrust from a propulsion system that is economical to manufacture through recirculation of a convective coolant either around or through a gap of the thrust chamber. Although specific implementations are illustrated and described herein, it will be appreciated by those of ordinary skill in the art that any arrangement which is calculated to achieve the same purpose can be substituted for the specific implementations shown. This application is intended to cover any adaptations or variations.

The systems, methods and apparatus described herein a low-cost rocket engine technology that can be used to produce rocket engines of a very wide range of thrust sizes or propellant combinations for private, commercial, or government aerospace programs. The economical engine systems, methods and apparatus described herein will increase the confidence of these organizations in obtaining rocket engines at greatly reduced cost and procurement times. In addition, the economical systems, methods and apparatus described herein reduce the procurement lead time of rocket engines and the procurement costs. The systems, methods and apparatus described herein provide faster and cheaper development and reproduction of rocket engines of a very wide range of thrust sizes or propellant combinations (i.e. combinations of fuel and oxidizer).

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to different thrust chambers 102, inside walls 204, combustion chambers 122, expansion nozzles 118, expansion nozzle interiors 206, expansion nozzle exteriors 208, main propellant injectors 116, oxidizers 105, fuels 103, internal film coolants 210, gaps 110, coolant tubes 504, convective coolants 214 and injectors 216.

The terminology used in this application meant to include injectors, fuel, thrust chambers and alternate technologies which provide the same functionality as described herein.

We claim:

1. A rocket engine comprising:
a thrust chamber having a gap between an inner shell and an outer shell, the inner shell and the outer shell being attached together to form the thrust chamber; and
a recirculating cooling system operably coupled to the gap in at least two locations and operable to recirculate a convective coolant through the gap.

2. The rocket engine of claim 1, wherein more convective coolant is pumped through the gap than is required to cool the thrust chamber below a maximum allowable temperature of the thrust chamber.

3. The rocket engine of claim 1, wherein convective coolant is pumped through the gap in an amount that is about 1.1 to 20 times more than what is required to cool the thrust chamber below a maximum allowable temperature of the thrust chamber.

4. The rocket engine of claim 1, wherein the recirculating cooling system further comprises:
a recirculating convective coolant loop that couples a coolant metering device, a heat exchanger, a recirculation pump, a pressure isolation valve, a pressure vent valve, a pressure check valve, a coolant feed tank, a coolant isolation valve and a gap fill valve.

5. The rocket engine of claim 4, wherein the recirculating cooling system further comprises:
a nozzle film coolant valve operably coupled to the recirculating convective coolant loop and operable to pass at least some of the convective coolant into the interior of the expansion nozzle.

6. The rocket engine of claim 5, wherein the recirculating cooling system further comprises:
an injector operably coupled to the nozzle film coolant valve and operable to inject at least some of the convective coolant into the interior of the expansion nozzle.

7. The rocket engine of claim 1, wherein at least one of the least two locations that the recirculating cooling system is operably coupled to the gap further comprises:
a manifold.

8. The rocket engine of claim 1, wherein the inner shell further comprises:
an Inconel shell structure.

9. The rocket engine of claim 1, wherein the each of the inner shell and the outer shell of the thrust chamber further comprises:
a wall having a thickness of between about 0.020 inches and about 0.1 inches.

10. The rocket engine of claim 1, wherein the convective coolant recirculates through the gap from the expansion nozzle and upwards towards a dome of the thrust chamber.

11. The rocket engine of claim 1, wherein the gap is between the inner and outer shell for less than the entirety of the thrust chamber and the convective coolant recirculates through a portion of the thrust chamber.

12. The rocket engine of claim 1, further comprising solid items in the gap to maintain the gap.

13. The rocket engine of claim 1 wherein the thrust chamber further comprises:
sheet metal.

14. The rocket engine of claim 1 wherein the thrust chamber further comprises:
metal selected from the group consisting of aluminum, steel, stainless steel, an austenitic nickel-based superalloy, Inconel, copper, bronze, alloys and mixtures thereof and metal and plastic composites thereof.

15. The rocket engine of claim 1 wherein the exterior of the inner shell further comprises:
an exterior that is enhanced to increase to heat transfer coefficient of the inner shell.

16. The rocket engine of claim 1 wherein the inner shell and the outer shell being attached directly together.

17. A method to cool a rocket engine, the method comprising:
flowing a convective coolant from entry point into a first location of a gap of a thrust chamber between an inner shell and an outer shell; and
circulating the convective coolant through the gap from the first location out though an exit point at a second location in the gap

18. The method of claim 17, wherein injecting the convective coolant further comprises:
injecting at least a portion of the convective coolant into an expansion nozzle of the thrust chamber.

19. A method to cool a rocket engine, the method comprising:
circulating a convective coolant at least twice through a gap between an inner shell of a thrust chamber and an outer shell of the thrust chamber; and
expending the convective coolant to the extent that substantially no convective coolant remains in the coolant feed tank when all of main propellant is expended.

20. The method of claim 19, wherein the expending further comprises:
dumping the convective coolant overboard through a coolant metering device.
